(19) United States
(12) Patent Application Publication
(10) Pub. No.: US 2026/0358487 A1
(43) Pub. Date: Nov. 12, 2026

(54) METHOD AND DEVICE FOR PROVIDING ULTRA-WIDEBAND COMMUNICATION-BASED SERVICE

(71) Applicant: Samsung Electronics Co., Ltd., Suwon-si, Gyeonggi-do (KR)

(72) Inventors: Yeonju LIM, Suwon-si (KR); Sungdong KIM, Suwon-si (KR); Youngsun RYU, Suwon-si (KR)

(21) Appl. No.: 19/138,458

(22) PCT Filed: Dec. 13, 2022
(86) PCT No.: PCT/KR2022/020266

§ 371 Date: Jun. 12, 2025

(51) Int. Cl. G01S 13/02; G01S 5/04; G01S 5/06; H04B 1/7163

(52) U.S. Cl. CPC G01S 13/0209; G01S 5/04; G01S 5/06; H04B 1/7163

(57) ABSTRACT

The present disclosure provides a method for providing a UWB-based service. A method of an electronic device for performing UWB communication according to an embodiment of the present disclosure may comprise the steps of broadcasting a UWB advertisement message for AoA measurement, receiving, from a first user device, first angle information obtained on the basis of reception of the UWB advertisement message and second angle information obtained on the basis of sensing information, identifying a pointing location pointed by the first user device, by using the first angle information, the second angle information, and distance information obtained on the basis of TWR with the first user device, and determining whether an item associated with the UWB-based service provided by the electronic device is selected, on the basis of the pointing location.

### CROSS-REFERENCE TO RELATED APPLICATIONS

This application is a U.S. National Phase Entry of PCT International Application No. PCT/KR 2022/020266, which was filed on Dec. 13, 2022, the disclosures of which are incorporated by reference herein in their entireties.

### TECHNICAL FIELD

The disclosure relates to UWB communication and, more particularly, to a method and an apparatus for providing a UWB-based service.

### BACKGROUND ART

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. Implementing the IoT requires technical elements, such as sensing technology, a wired/wireless communication and network infrastructure, service interface and security technologies. A recent ongoing research for thing-to-thing connection is on techniques for sensor networking, machine-to-machine (M2M), or machine-type communication (MTC).

In the IoT environment, intelligent Internet Technology (IT) services may be offered that collect and analyze the data generated by the things connected with one another to create human life a new value. The IoT may have various applications, such as the smart home, smart building, smart city, smart car or connected car, smart grid, health-care, or smart appliance industry, or state-of-art medical services, through conversion or integration of conventional information technology (IT) techniques and various industries.

With the advance of wireless communication systems, various services can be provided, and accordingly there is a need for ways to effectively provide these services. For example, a ranging technology for measuring the distance between electronic devices by using an ultrawide band (UWB) may be used.

### DETAILED DESCRIPTION OF THE INVENTION

### Technical Problem

The disclosure provides a method of providing a UWB-based service.

### Technical Solution

In accordance with an aspect of the disclosure, a method of an electronic device performing UWB communication may include broadcasting a UWB advertisement message for angle of arrival (AoA) measurement, receiving, from a first user device, first angle information acquired based on the UWB advertisement message being received, and second angle information acquired based on sensing information, identifying a pointing location, pointed by the first user device, by using the first angle information, the second angle information, and distance information acquired based on two-way ranging (TWR) with the first user device, and determining whether an item associated with a UWB-based service provided by the electronic device is selected based on the pointing location.

In accordance with another aspect of the disclosure, a method of a user device performing UWB communication may include receiving a UWB advertisement message for angle of arrival (AoA) measurement, acquiring first angle information, based on the UWB advertisement message being received, and second angle information, based on sensing information, determining whether there is a user's intention to use a UWB-based service provided by an electronic device transmitting the UWB advertisement message, based on at least one of the first angle information and the second angle information, and in case that there is the user's intention, transmitting the first angle information and the second angle information to the electronic device, and the first angle information and the second angle information may be used to identify a pointing location of the user device.

### BRIEF DESCRIPTION OF DRAWINGS

FIG. 1 illustrates the exemplary architecture of a UWB device according to an embodiment of the disclosure.

FIG. 2A illustrates an exemplary configuration of a communication system including an electronic device supporting a UWB-based service according to an embodiment of the disclosure.

FIG. 2B illustrates an exemplary configuration of a communication system including an electronic device supporting a UWB-based service according to an embodiment of the disclosure.

FIG. 3A illustrates the structure of a UWB MAC frame according to an embodiment of the disclosure.

FIG. 3B illustrates the structure of a UWB PHY packet according to an embodiment of the disclosure.

FIG. 4A illustrates an example of a ranging block structure according to an embodiment of the disclosure.

FIG. 4B illustrates an example of a ranging round according to an embodiment of the disclosure.

FIG. 5 illustrates various examples of a UWB ranging method according to an embodiment of the disclosure.

FIG. 6 illustrates an example of a procedure for providing the UWB-based service according to an embodiment of the disclosure.

FIG. 7 illustrates an example of a scenario of providing the UWB-based service using a UWB pointing according to an embodiment of the disclosure.

FIG. 8 illustrates an example of a procedure for UWB pointing according to an embodiment of the disclosure.

FIG. 9 illustrates an example of a method by which the user device selects an item by using a UWB pointing function according to an embodiment of the disclosure.

FIG. 10 is a flowchart illustrating a method by which the user device selects an item by using a UWB pointing function according to an embodiment of the disclosure.

FIG. 11 is a flowchart illustrating a method by which the user device selects an item by using a UWB pointing function according to an embodiment of the disclosure.

FIG. 12 illustrates an example of a BLE advertisement message according to an embodiment of the disclosure.

FIG. 13 illustrates an example of the UWB advertisement message according to an embodiment of the disclosure.

FIG. 14 illustrates an example of a method by which the user device controls an order by using a UWB pointing function according to an embodiment of the disclosure.

FIG. 15 is a flowchart illustrating a method by which the user device controls a kiosk order by using a UWB pointing function.

FIG. 16 illustrates an example of a UWB message according to an embodiment of the disclosure.

FIG. 17 illustrates an example of the payload included in the content field of the UWB message of FIG. 16.

FIG. 18 illustrates an example of payload data included in the payload of FIG. 17.

FIG. 19 illustrates an example of payload data included in the payload of FIG. 17 of the disclosure.

FIG. 20 illustrates an example of a method of providing a notification to the user device according to an embodiment of the disclosure.

FIG. 21 illustrates an example of a method of providing a notification to the user device when a UWB payment method is used according to an embodiment of the disclosure.

FIG. 22 illustrates an example of a method of providing the notification to the user device when a QR code payment method is used according to an embodiment of the disclosure.

FIG. 23 illustrates an example of information elements including device information according to an embodiment of the disclosure.

FIG. 24 illustrates another example of the information elements including the device information according to an embodiment of the disclosure.

FIG. 25 illustrates an example of a BLE advertisement message according to an embodiment of the disclosure.

FIG. 26 illustrates an example of a UWB advertisement message according to an embodiment of the disclosure.

FIG. 27 illustrates a method of the user device according to an embodiment of the disclosure.

FIG. 28 illustrates a method of the kiosk according to an embodiment of the disclosure.

FIG. 29 illustrates a configuration of a UWB device according to an embodiment of the disclosure.

### MODE FOR CARRYING OUT THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, according to some embodiments, the “unit” may include one or more processors.

As used herein, the term “terminal” or “device” may also be referred to as a mobile station (MS), a user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms. Various examples of the terminal may include a cellular phone, a smartphone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storage and playback home appliance having a wireless communication function, an Internet hole appliance capable of wireless Internet access and browsing, and portable units or terminals having integrated combinations of these functions. Furthermore, the terminal may include a machine to machine (M2M) terminal, and a machine type communication (MTC) terminal/device, but is not limited thereto. In the specification, the terminal may also be referred to as an electronic device or simply as a device.

Hereinafter, the operation principle of the disclosure will be described in detail in conjunction with the accompanying drawings. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Hereinafter, embodiments of the disclosure will be described in detail in conjunction with the accompanying drawings. In the following description of embodiments of the disclosure, a communication system using a UWB will be described by way of example, but the embodiments of the disclosure may be applied to other communication systems having similar technical backgrounds or characteristics. Examples of such communication systems may include communication systems using Bluetooth or ZigBee. Therefore, based on determinations by those skilled in the art, the embodiments of the disclosure may be applied to other communication systems through some modifications without significantly departing from the scope of the disclosure.

Also, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In general, a wireless sensor network technology is largely divided into a wireless local area network (WLAN) technology and a wireless personal area network (WPAN) technology according to the recognized distance. At this time, the WLAN corresponds to a technology based on IEEE 802.11 capable of accessing a backbone network within a radius of 100 m. Further, the WPAN corresponds to a technology based on IEEE 802.15 and may include Bluetooth, ZigBee, ultra-wideband (UWB), and the like. A wireless network for implementing the wireless network technologies may include a plurality of electronic devices.

According to the definition of federal communications commission (FCC), the UWB may be a wireless communication technology using bandwidths higher than or equal to 500 MHz or in which bandwidths corresponding to the center frequency are 20% or more. The UWB may be a band itself to which UWB communication is applied. The UWB allows secure and accurate ranging between devices. Accordingly, the UWB enables relative location estimation based on the distance between two devices or accurate location estimation of a device based on the distance from fixed devices (of which locations are known).

Specific terms used in the following description are provided to assist understanding of the disclosure, and the use of the specific terms may be modified in different forms without departing from the technical idea of the disclosure.

An “application dedicated file (ADF)” may be a data structure within application data structure capable of hosting, for example, an application or application-specific data.

An “application protocol data unit (APDU)” may be a command and a response used for communication with application data structure within a UWB device.

“Application-specific data” may be, for example, a file structure having a root level and an application level including UWB controlee information and UWB session data required for a UWB session.

A “controller” may be a ranging device for defining and controlling ranging control messages (RCMs) (or control messages). The controller may define and control ranging features by transmitting a control message.

A “controlee” may be a ranging device using a ranging parameter within an RCM (or a control message) received from a controller. The controlee may use ranging features configured through the control message from the controller.

A “dynamic scrambled timestamp sequence (STS) mode” may be an operation mode in which the STS is not repeated for a ranging session unlike a “static STS”. In this mode, the STS may be managed by a ranging device and a ranging session key for generating the STS may be managed by a secure component.

An “applet” may be, for example, an applet executed on a secure component including UWB parameters and service data. The applet may be a FiRa applet.

A “ranging device” may be a device capable of performing UWB ranging. In the disclosure, the ranging device may be an enhanced ranging device (ERDEV) defined in IEEE 802.15.4z or a FiRa device. The ranging device may be referred to as a UWB device.

A “UWB-enabled application” may be an application for a UWB service. For example, the UWB-enabled application may be an application using a framework API for configuring an OOB connector, a secure service, and/or a UWB service for a UWB session. The “UWB-enabled application” may be abbreviated as an application or a UWB application. The UWB-enabled application may be a FiRa-enabled application.

A “framework” may be a component for providing access to a profile, an individual UWB configuration, and/or a notification. The framework may be a set (collection) of logical software components including, for example, a profile manager, an OOB connector, a secure service, and/or a UWB service. The framework may be a FiRa framework.

An “OOB connector” may be a software component for configuring an out-of-band (OOB) connection (for example, a BLE connection) between ranging devices. The OOB connector may be a FiRa OOB connector.

A “profile” may be a predefined set of a UWB and an OOB configuration parameter. The profile may be a FiRa profile.

A “profile manager” may be a software component for implementing a profile available by a ranging device. The profile manager may be a FiRa profile manager.

A “service” may be implementation of a use case for providing a service to an end-user.

A “smart ranging device” may be a ranging device capable of implementing an optional framework API. The smart ranging device may be a FiRa smart device.

A “global dedicated file (GDF)” may be a root level of application-specific data including data required for configuring a USB session.

A “framework API” may be an API used by a UWB-enabled application for communication with a framework.

An “initiator” may be ranging device initiating a ranging exchange. The initiator may initiate ranging exchange by transmitting a first RFRAME (ranging exchange message).

An “object identifier (OID)” may be an identifier of an ADF within an application data structure.

An “out-of band (OOB)” may be data communication that does not use a UWB as an underlying wireless technology.

A “ranging data set (RDS)” may be data (for example, a UWB session key, a session ID, or the like) required for configuring a UWB session required to protect confidentiality, authenticity, and integrity.

A “responder” may be a ranging device transmitting a response to an initiator in a ranging exchange. The responder may respond to the ranging exchange message received from the initiator.

An “STS” may be a ciphered sequence for increasing integrity and accuracy of ranging measurement timestamps. The STS may be generated from a ranging session key.

A “secure channel” may be a data channel for preventing overhearing and tempering.

A “secure component” may be an entity (for example, a secure element (SE) or a trusted execution environment (TEE)) having a defined security level which interfaces with a UWBS in order to provide an RDS to the UWBS when, for example, a dynamic STS is used.

The “SE” may be a tamper-resistant secure hardware component which can be used as a secure component within a ranging device.

“Secure ranging” may be ranging based on an STS generated through a robust ciphering operation.

A “secure service” may be a software component for interfacing with a secure component such as a secure element or a TEE.

A “service applet” may be an applet on a secure component handling a service-specific transaction.

“Service data” may be data defined by a service provider, which is required to be transmitted between two ranging devices in order to implement a service.

A “service provider” may be an entity for defining and providing hardware and software required for providing a specific service to an end-user.

A “static STS mode” is an operation mode in which an STS is repeated during a session and does not need to be managed by a secure component.

A “secure UWB service (SUS) applet” may be an applet on an SE communicating with an applet in order to search for data required for enabling a secure UWB session with another ranging device. Further, the SUS applet may transmit corresponding data (information) to a UWBS.

A “UWB service” may be a software component providing access to a UWBS.

A “UWB session” may be a period from the start of communication between a controller and a controlee through a UWB to the stop of the communication. The UWB session may include ranging, data transmission, or both the ranging and the data transmission.

A “UWB session ID” may be an ID (for example, an 32-bit integer) for identifying a UWB session shared between a controller and a controlee.

A “UWB session key” may be a key used for protecting a UWB session. The UWB session key may be used to generate an STS. The UWB session key may be a UWB ranging session key (URSK) and may be abbreviated as a session key.

A “UWB subsystem (UWBS)” may be a hardware component implementing UWB PHY and MAC layers (specifications). The UWBS may have an interface for a framework and an interface for a secure component for searching for an RDS.

“Scheduling-based ranging (scheduled based ranging)” may be used for ranging round scheduled by the controller to transmit a ranging frame (RFRAME) and/or a measurement report in different ranging slots by controlees. The scheduling-based ranging may be referred to as time-scheduled ranging. A scheduling mode using the scheduling-based ranging may be referred to as a time-scheduled mode. For example, time-scheduled two way ranging may be used as the scheduling-based ranging.

“Contention-based ranging” may be used when the controller is not aware of MAC addresses of controlees participating in a UWB session (ranging session). In the contention-based ranging, the controller may be an initiator and perform ranging with an unknown UWB device. A scheduling mode using the contention-based ranging may be referred to as a contention-based mode.

The contention-based ranging may be used for a ranging round that determines the size of a contention access period (CAP) and inform the CAP size through a ranging message by the controller. The CAP may be referred to as a contention window or a contention window period.

In the contention-based mode (for example, contention-based two way ranging), the UWB device may operate as the controller and the initiator, in which case a ranging control phase (RCP) and a ranging initiation phase (RIP) may be integrated into one phase (for example, RIP). In a ranging phase (RP), allocation of the CAP size may determine the CAP period for responder(s) that participate in the corresponding ranging round in units of ranging slots. Each responder may randomly determine one slot within the CAP in order to transmit a ranging response message (RRM). Messages used in the contention-based ranging may use SP1 as an RFRAME configuration.

“Hybrid ranging” may be used when there is a known controlee and an unknown controlee. As described above, the known controlee may be a controlee of which the MAC address is known by the controller, and the unknown controlee may be a controlee of which the MAC address is not known by the controller. The hybrid ranging may be referred to as hybrid-based ranging. A scheduling mode using the hybrid ranging may be referred to as a hybrid-based mode.

In the hybrid-based mode, the controller may perform ranging with the known controlee in the scheduling-based mode and with the unknown controlee in the contention-based mode.

In the hybrid-based mode, the ranging round may include a ranging control phase (RCP) and a ranging phase (RP). The RP may include a contention free period (CFP) for scheduling-based ranging (access) and a contention access period (CAP) for contention-based ranging. A control message (ranging control message) used in the RCP of the hybrid-based mode may be referred to as ranging management message (RMM).

A “UWB message” may be a message including a payload IE transmitted by the UWB device (for example, ERDEV). The UWB message may be a message, for example, a ranging initiation message (RIM), a ranging response message (RRM), a ranging final message (RFM), a control message (CM), a measurement report message (MRM), a ranging result report message (RRRM), a control update message (CUM), or a one-way ranging (OWR) message. As necessary, a plurality of message may be integrated into one message.

A “payload IE” may be called a payload information element and may be included in a MAC payload of a UWB MAC frame defined in IEEE 802.15.4/4z. The MAC payload may include a plurality of payload IEs.

A “data message IE (data message payload IE)” may be an additional payload IE for transmitting application data. The application data may be data transmitted from a higher framework or application of the UWB MAC layer.

The data message IE may be used during a two-way ranging (TWR) procedure. In this case, the ranging message (UWB message) may include at least one or both of the payload IE for ranging and the data message ID for transmitting application data. For example, the data message IE may be transmitted while being included as a part of the payload IE of the MAC payload of a ranging initiation message (RIM), a ranging response message (RRM), a ranging final message (RFM), a measurement report message (MRM), and a ranging result report message (RRRM) for ranging.

The data message IE may be used during a one-way ranging (OWR) procedure for angle of arrival (AoA) measurement. In this case, the AoA measurement message may include at least one or both of the payload IE for AoA measurement and the data message IE for transmitting application data. For example, the data message IE may be transmitted while being included as a part of the payload IE of the MAC payload of the AoA measurement message.

“OWR” may be a ranging method using messages transmitted in one way between the ranging device and one or more different ranging devices. The OWR may be used to measure time difference of arrival (TDoA). In addition, the OWR may be used to measure the AoA by the receiving side rather than measuring the TDoA (one-way ranging for AoA measurement ranging method). In this case, a pair of one advertiser and one observer may be used. The OWR for measuring the AoA may allow the observer to receive an OWR message from the advertiser and allow the observer to measure the AoA to determine a user's intention, action, or motion. For example, the user's contention to control a specific advertiser may be verified by the result of AoA measurement for OWR messages from the advertiser. In the disclosure, the OWR may be referred to as a UWB OWR.

The “advertiser” is a ranging device transmitting an AoA measurement message. The advertiser may insert application data (application payload data) as a part of the MAC payload of the AoA measurement message by using the data message IE. The application data may be configured by an upper layer. In the disclosure, the advertiser may be referred to as an advertiser device or a UWB advertiser device. In the disclosure, the AoA measurement message may be referred to as an OWB message for AoA measurement, a UWB OWR message for AoA measurement, a UWB advertisement message, an advertisement message, or the like.

An “observer” is a ranging device that receives an AoA measurement message and measures AoA for each message. The observer may transmit the measured AoA to the upper layer. When application data is included in the MAC payload of the AoA measurement message, the observer may transmit the same to the upper layer. In the disclosure, the observer may be referred as an observer device or a UWB observer device.

“TWR” may be a ranging method for measuring time of flight (ToF) through exchange of ranging messages between two devices and measuring the relatively distance between the two devices. The TWR scheme may be one of double-sided two-way ranging (DS-TWR) and single-sided two-way ranging (SS-TWR). The SS-TWR may be procedure in which ranging is performed through one round-trip time measurement. For example, the SS-TWR may include an operation of transmitting the RIM from the initiator to the responder and an operation of transmitting the RRM from the responder to the initiator. The DS-TWR may be procedure in which ranging is performed through two round-trip time measurement. For example, the DS-TWR may include an operation of transmitting the RIM from the initiator to the responder, an operation of transmitting the RRM from the responder to the initiator, and an operation of transmitting the RRM from the initiator to the responder. Through such ranging exchange (ranging message exchange), the time of flight (ToF) may be calculated and the distance between two devices may be estimated. Meanwhile, during the TWR procedure, measured AoA information (for example, AoA azimuth result and AoA elevation result) may be transferred to another ranging device through the RRM or another message. In the disclosure, the TWR may be referred to as UWB TWR.

“DL-TDoA may be called downlink time difference of arrival (DL-TDoA) or reverse TDoA and an operation in which a user device (tag device) overhears (or receives) a message of an anchor device during a process in which a plurality of anchor devices broadcasts messages or exchanges messages with each other may be a basic operation. The DL-TDoA may be classified as the type of one way ranging like the uplink TDoA. The user device performing the DL-TDoA may overhear a message transmitted by two anchor devices and calculate the TDoA that is proportional to the distance between each anchor device and the user device. The user device may calculate the distance relative to anchor devices by using the TDoA with several pairs of anchor devices and use the same for positioning. The operation of the anchor device for the DL-TDoA may include, for example, an operation similar to the DS-TWR defined in IEEE 802.15.4z, and may further include other useful time information to allow the user device to calculate the TDoA. The DL-TDoA may be referred to as DL-TDoA localization.

“Uplink TDoA (UL-TDoA)” may be a ranging method in which the UWB tag transmits or broadcasts a ranging message and at least one UWB anchor acquires TDoA, based on the received ranging message, and estimates the location of the UWB tag, based on the TDoA.

“AoA” is an arrival angle of a received signal and may be expressed as a relative angle such as AoA azimuth and AoA elevation. For example, it may be assumed that the electronic device is an electronic device having a display, a Y axis is a vertical display axis of the electronic device, an X axis is a horizontal display axis of the electronic device, and a Z axis is orthogonal to the display of the electronic device. In this case, an AoA azimuth angle may be a relatively angle between an input signal projected onto the XZ plane and the Z axis, and an AoA elevation angle may be a relative angle between the input signal and the XZ plane.

In the case of TWR, the controller (and/or initiator) may measure the AoA azimuth for the RRM and transfer the measured AoA azimuth to an upper layer through a UCI notification message. The controlee (and/or responder) may measure the AoA azimuth for the RIM message and transmit the measured AoA azimuth through the RRM.

In the case of TWR, the controller (and/or initiator) may measure the AoA elevation for the RRM and transfer the measured AoA elevation to an upper layer through a UCI notification message. The controlee (and/or responder) may measure the AoA elevation for the RIM message and transmit the measured AoA elevation through the RRM.

In the case of OWR, the observer may measure the AoA azimuth and the AoA elevation for the AoA measurement message.

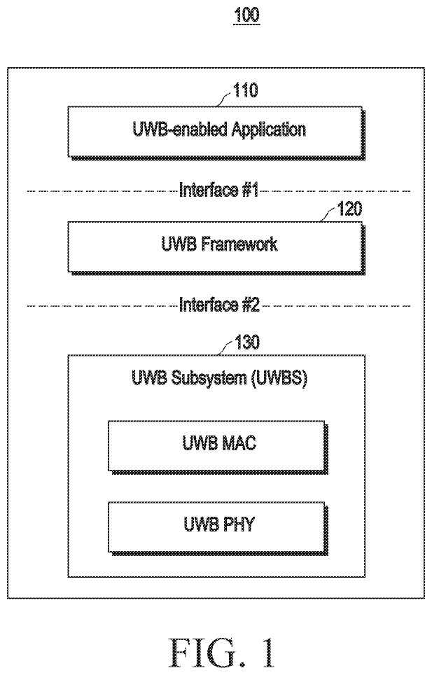

FIG. 1 illustrates the exemplary architecture of a UWB device according to an embodiment of the disclosure.

A UWB device 100 may be an electronic device supporting UWB communication. The UWB device 100 may be, for example, a ranging device supporting UWB ranging. In an embodiment, the ranging device may be an enhanced ranging device (ERDEV) defined in IEEE 802.15.4z or a FiRa device.

In the embodiment of FIG. 1, the UWB device 100 may interact with another UWB device through a UWB session.

Further, the UWB device 100 may implement a first interface (interface #1) which is an interface between a UWB-enabled application 110 and a UWB framework 120, and the first interface may allow the UWB-enabled application 110 in the UWB device 100 to use UWB capabilities of the UWB device 100 in a predetermined scheme. In an embodiment, the first interface may be a framework API or a proprietary interface, but is not limited thereto.

Further, the UWB device 100 may implement a second interface (interface #2) which is an interface between the UWB framework 110 and a UWB subsystem (UWBS) 130. In an embodiment, the second interface may be a UWB command interface (UCI) or a proprietary interface, but is not limited thereto.

Referring to FIG. 1, the UWB device 100 may include the UWB-enabled application 110, the framework (UWB framework) 120, and/or the UWBS 130 including a UWB MAC layer and a UWB physical layer. According to an embodiment, some entities may not be included in the UWB device or an additional entity (for example, security layer) may be further included.

The UWB-enabled application 110 may trigger a configuration of a UWB session by the UWBS 130 through the first interface. Further, the UWB-enabled application 110 may use one of the predefined profiles. The UWB-enabled application 110 may handle relevant events such as service discovery, ranging notifications, and/or error conditions through the first interface.

The framework 120 may provide access to a profile, an individual UWB configuration, and/or a notification. Further, the framework 120 may support at least one of a function for performing UWB ranging and transaction, a function for providing an interface for an application and the UWBS 130, or a function for estimating a location of the UWB device 100. The framework 120 may be a set of software components. As described above, the UWB-enabled application 110 may interface with the framework 120 through the first interface, and the framework 120 may interface with the UWBS 130 through the second interface.

Meanwhile, in the disclosure, the UWB-enabled application 110 and/or the framework 120 may be implemented by an application processor (AP) (or processor). Accordingly, in the disclosure, it may be understood that the operation of the UWB-enabled application 110 and/or the framework 120 is performed by the AP (or processor). In the disclosure, the framework may be referred to as an AP or a processor.

The UWBS 130 may be a hardware component including a UWB MAC layer and a UWB physical layer. The UWBS 130 may manage a UWB session and communicate with a UWBS of another UWB device. The UWBS 130 may interface with the framework 120 through the second interface and acquire security data from the secure component. In an embodiment, the framework (or application processor) 120 may transmit a command to the UWBS 130 through UCI, and the UWBS 130 may transfer a response to the instruction to the framework 120. The UWBS 130 may transfer a notification to the framework 120 through UCI.

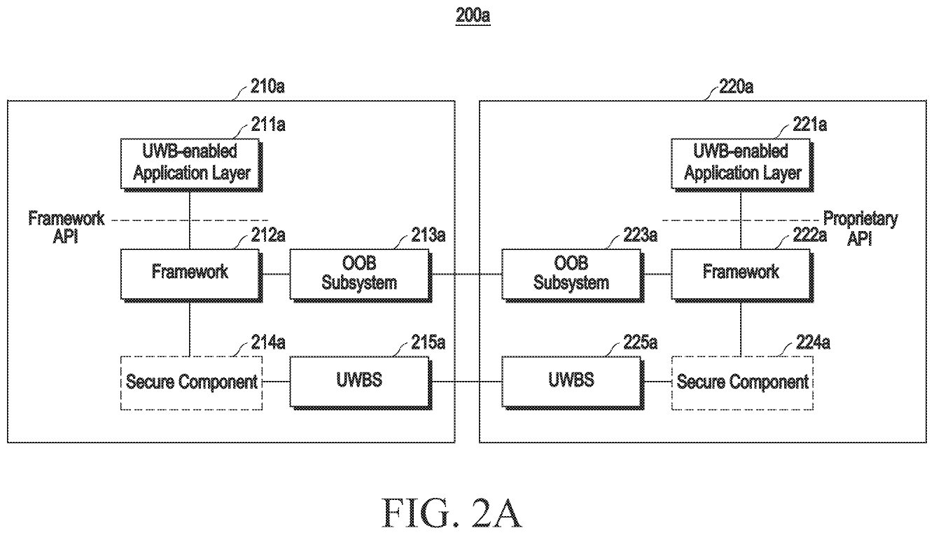

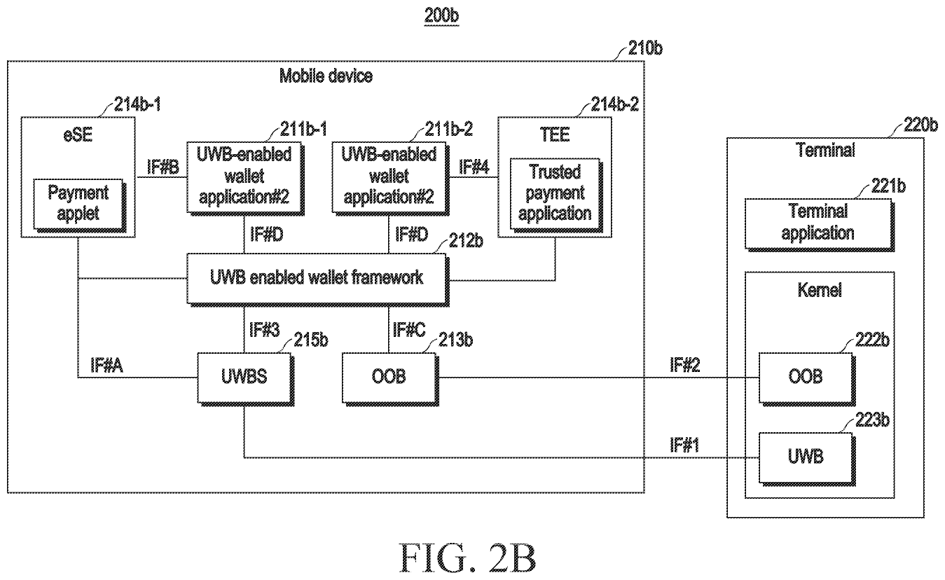

FIG. 2A illustrates an exemplary configuration of a communication system including an electronic device supporting a UWB-based service according to an embodiment of the disclosure.

Referring to FIG. 2A, a communication system 200a includes a first electronic device 210a and a second electronic device 220a.

As an embodiment, the first electronic device 210a and the second electronic device 220a may be, for example, the UWB device of FIG. 1 or electronic devices including the UWB device of FIG. 1. For example, the first electronic device 210a may be, for example, a smart ranging device or a ranging device, and the second electronic device 220a may be, for example, a smart ranging device or a ranging device. As an embodiment, the smart ranging device or the ranging device may be an enhanced ranging device (ERDEV) defined in IEEE 802.15.4z or a FiRa device. In FIG. 2A, the first electronic device may be referred to as a first UWB device, and the second electronic device may be referred to as a second UWB device.

The first electronic device 210a may host, for example, one or more UWB-enabled applications which can be installed by a user (for example, a mobile phone). This may be based on a framework API. The second electronic device 220a may use a proprietary interface to implement, for example, a specific UWB-enabled application that is provided by only a manufacturer without providing the framework API. Meanwhile, unlike FIG. 2, both the first UWB device and the second UWB device may be ranging devices using the framework API or both the first UWB device and the second UWB device may be ranging devices using the proprietary interface according to an embodiment.

The first electronic device 210a and the second electronic device 220a may include UWB-enabled application layers 211a and 221a, frameworks 212a and 222a, OOB components (OOB subsystems) 213a and 223a, secure components 214a and 224a, and/or UWBSs 215a and 225a, respectively. According to an embodiment, some components may be omitted or additional components may be further included.

The first electronic device 210a and the second electronic device 220a may generate an OOB connection (channel) through the OOB components 213a and 223a and generate a UWB connection (channel) through the UWBSs 215a and 225a, so as to communicate with each other.

The frameworks 212a and 222a may serve to provide access to a profile, an individual UWB configuration, and/or a notification. The frameworks 212a and 222a are a set of software components and may include, for example, a profile manager, an OOB connector, a secure service, and/or a UWB service.

The OOB components 213a and 223a may be hardware components including a MAC layer and/or a physical layer for OOB communication (for example, BLE communication). The OOB components 213a and 223a may communicate with an OOB component of another device. In an embodiment, the first UWB device 210a and the second UWB device 220a may generate the OOB connection (channel) by using the OOB components 213a and 223a and exchange parameters for configuring a UWB session through the OOB channel. In the disclosure, the OOB components 213a and 223a may be referred to as OOB subsystems.

The secure components 214a and 224a may be hardware components interfacing with the framework and/or the UWBS to provide the RDS. As an embodiment, the secure components 214a and 224a may be SE (for example, eSE), TEE (or a trusted application within TEE)), or strongbox (SB).

The UWBSs 215a and 225a may be hardware components including a UWB MAC layer and a UWB physical layer. The UWBSs 215a and 225a may manage a UWB session and communicate with a UWBS of another UWB device. In an embodiment, the first UWB device 210a and the second UWB device 220a may perform UWB ranging and transaction of service data through the UWB session configured through the UWBSs 215a and 225a by using exchanged parameters.

In the disclosure, the UWB-enabled application layer and/or the framework may be implemented by an application processor (AP) (or processor). Accordingly, in the disclosure, the operation of the UWB-enabled application layer and/or the framework may be performed by an application processor (AP) (or processor).

FIG. 2B illustrates an exemplary configuration of a communication system including an electronic device supporting a UWB-based service according to an embodiment of the disclosure.

The embodiment of FIG. 2B may be one example of the embodiment of FIG. 2A.

In the embodiment of FIG. 2B, the UWB-based service may be a UWB-based payment service (wallet service). In the disclosure, embodiments of the disclosure are described based on the assumption that the UWB-based service is the UWB-based payment service, but embodiments of the disclosure may be applied to another type of UWB-based service.

Referring to FIG. 2B, the communication system 200b providing the UWB-based payment service may include a first electronic device 210b and a second electronic device 220b. In FIG. 2B, the first electronic device may be referred to as a first UWB device, and the second electronic device may be referred to as a second UWB device.

### First Electronic Device 210b

The first electronic device 210b may be an electronic device of a user (for example, a mobile device of a user) for the UWB-based payment service. The first electronic device 210b may include at least one UWB-enabled wallet application (UWB-enabled application) 211b-1 and 211b-2, a UWB-enabled wallet framework (framework) 212b, an OOB component 213b, at least one security component 214b-1 and 214b-2, and/or a UWBS 215b. For description of each component, refer to the description of FIG. 2A.

Meanwhile, in the embodiment of FIG. 2B, it is described that the UWB-enabled application corresponds to a UWB-enabled wallet application and the framework corresponds to a UWB-enabled wallet framework for convenience of description, but the embodiment is not limited thereto and various UWB-enabled applications and frameworks for providing various types of UWB-based service may be implemented. In FIG. 2B, the UWB-enabled wallet application may be referred to as a UWB-enabled application, a UWB-enabled payment application, or the like, and the UWB-enabled wallet framework may be referred to as a UWB-enabled payment framework, a framework, or the like.
(1) The UWB-enabled applications 211b-1 and 211b-2 may support at least one of the following features.
   hosts an applet (payment applet) for UWB-based payment within a SE (for example, embedded SE (eSE)) or a trusted application (trusted payment application) for UWB-based payment within a TEE.
   when requested by the framework, provides deployment information of anchors for estimating the location of the first electronic device and/or a UWB block structure (for example, a ranging block structure).
   communicates with the second electronic device and a back-end server for personalization of the payment applet or the trusted payment application (TPA).
(2) The framework 212b may support at least one of the following features.
   estimates the location of the first electronic device.
   implements UCI commands.
   provides a set of APIs by which the UWB-enabled application approaches the UWBS and the OOB component.
(3) The OOB component 213b may support the following features.
   implements an OOB connection operation (for example, a BLE connection operation).
(4) The trusted payment application 211b-2 may be included in the TEE and may support at least one of the following features.
   supports a TEE client API.
   implements a trusted application.
   implements a secure channel protocol to communicate with the second electronic device in a secure manner.
   hosts payment credential and cryptographic keys for a secure channel.
   hosts important information (for example, card information) for supporting the UWB-based payment service.
(5) The payment applet 211b-1 may be included in the SE (eSE) and may support at least one of the following features.
   supports a APDU.
   implements a secure channel protocol to communicate with the second electronic device in a secure manner.
   hosts payment credential and cryptographic keys for a secure channel.
   hosts important information (for example, card information) for supporting the UWB-based payment service.

Each element of the first electronic device 210b may communicate with another element through a predefined interface (IF). Hereinafter, each interface is described.
IF #1: an interface between the UWBS 215b of the first electronic device 210a and a UWBS of another electronic device (for example, the UWBS 223b of the second electronic device 220b). IF #1 may be used to exchange a UWB message and/or payment transaction.
IF #2: an interface between the OOB component 213b of the first electronic device 210b and an OOB component of another electronic device (for example, the OOB component 222b of the second electronic device 220b). IF #2 may be used to exchange an OOB message.

IF #3: an interface between the framework 212b and the UWBS 215b. IF #3 may be used to exchange a UCI message. For example, IF #3 may be used to exchange a UCI message (for example, UCI command/UCI notification, or the like) for configuring a secure channel between the trusted payment application 211b-2 and the UWBS 215b.
IF #4: an interface between the UWB-enabled application 211b-2 and the trusted payment application 211b-2 within the TEE IF #4 may be used to exchange TEE commands through the TEE client API. For example, IF #4 may be used to exchange TEE commands for configuring a secure channel between the trusted payment application 211b-2 and the UWBS 215b.

IF #A: an interface between the UWB-enabled application 211b-1 and 211b-2 and the UWB 215b. IF #A may be, for example, a SUS external API.
IF #B: an interface between the UWB-enabled application 211b-2 and the payment application 214b-1 within the SE (eSE). IF #B may be used to exchange a APDU through an object management application programming interface (OMAPI). For example, IF #B may be used to exchange an APDU for configuring a secure channel between the eSE and the UWBS.
IF #C: an interface between the OOB component 213b and the framework 212b or the UWB-enabled applications 211b-1 and 211b-2. For example, IF #C may be a host controller interface (HCl).
IF #D: an interface between the UWB-enabled applications 211b-1 and 211b-2 and the framework 212b. IF #D may be an API (framework API) provided by the framework 212b.

Meanwhile, although not illustrated in FIG. 2B, an interface between the TA (for example, trusted payment application) within the TEE 214b-2 and the UWBS 215b may be configured or defined to transmit the RDS including a UWB session key. In this case, in order to protect the interface between the TEE and the UWBS 215b, a secure channel between the TA and the UWBS 215b may be configured. Further, it is possible to connect the TA and the UWBS 215b at an HW level by newly configuring a driver TA.

### Second Electronic Device 220b

The second electronic device 220b may be an electronic device (for example, a payment terminal (for example, a point of service (PoS) terminal of retail) of an operator for the UWB-based payment service. The second electronic device 220b may include a terminal application 221b, an OOB component 222b, and/or a UWBS 223b. As an embodiment, the terminal application 221b may be a UWB-enabled application.

According to an embodiment, not only the user device for the UWB-based payment service, but also the payment terminal may have the same configuration as the configuration of the first electronic device 220b.

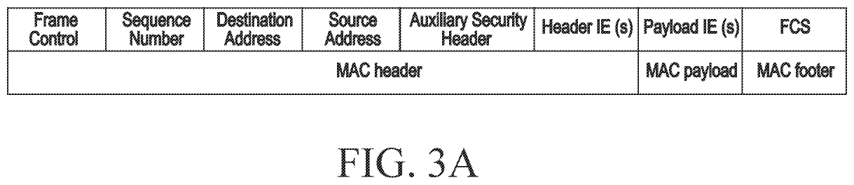

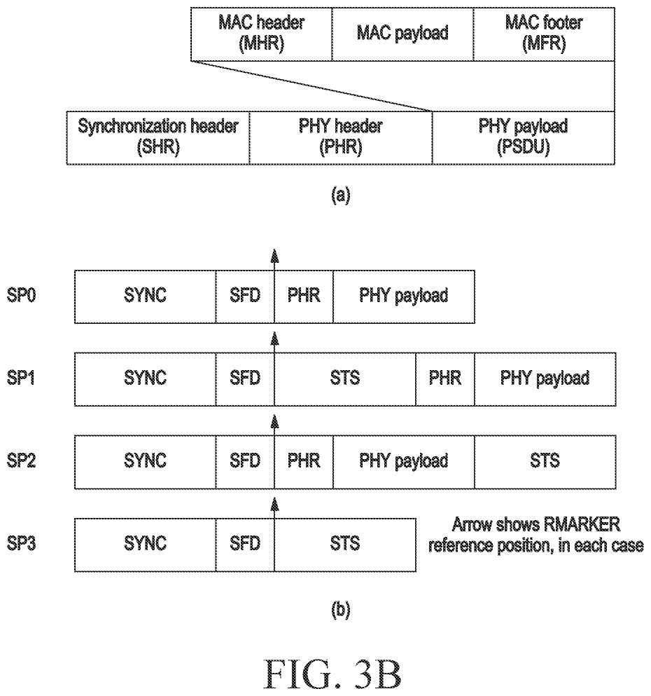

FIG. 3A illustrates the structure of a UWB MAC frame according to an embodiment of the disclosure.

In the embodiment of FIG. 3A, the UWB MAC frame may be abbreviated as a MAC frame or a frame. As an embodiment, the UWB MAC frame may be used to transmit UWB-related data (for example, a UWB message, a ranging message, control information, service data, application data, or the like).

Referring to FIG. 3A, the UWB MAC frame may include a MAC header (MHR), a MAC payload, and/or a MAC footer (MFR)

(1) MAC header

The MAC header may include a frame control field, a sequence number field, a destination address field, a source address field, an auxiliary security header field, and/or at least one header IE field. According to an embodiment, some of the fields may not be included in the MAC header or additional field(s) may be further included in the MAC header.

In an embodiment, the frame control field may include a frame type field, a security enabled field, a frame pending field, an ack request (AR) field, a PAN ID compression field (PAN ID present field), a sequence number suppression field, an IE present field, a destination addressing mode field, a frame version field, and/or a source addressing mode field. According to an embodiment, some of the fields may not be included in the frame control field and additional field(s) may be further included in the frame control field.

Each field is described below.

The frame type field may indicate a frame type. As an embodiment, the frame type may include a data type and/or a multipurpose type.

The security-enabled field may indicate whether there is an auxiliary security header field. The auxiliary security header field may include information required for security processing.

The frame pending field may indicate whether a device transmitting a frame has more data for a recipient. That is, the frame pending field may inform of whether there is a pending frame for a recipient.

The ack request (AR) field may indicate whether acknowledgment for reception of the frame is requested from a recipient.

The PAN ID compression field (PAN ID present field) may indicate whether there is a PAN ID field.

The sequence number suppression field may indicate whether there is a sequence number field. The sequence number field may indicate a sequence identifier for the frame.

The IE present field may indicate whether the header IE field and the payload IE field are included in the frame.

The destination addressing mode field may indicate whether the destination address field includes a short address (for example, 16 bits) or an extended address (for example, 64 bits). The destination address field may indicate an address of the recipient of the frame.

The frame version field may indicate a frame version. For example, the frame version field may be set to a value indicating IEEE std 802.15.4z-2020.

The source addressing mode field may indicate whether there is a source address field and, when there is a source address field, whether the source address field includes a short address (for example, 16 bits) or an extended address (for example, 64 bits). The source address field may indicate an address of an originator of the frame.

(2) MAC payload

The MAC payload may include at least one payload IE field. In an embodiment, the payload IE field may include a vendor-specific nested IE.

(3) MAC footer

The MAC footer may include an FCS field. The FCS field may include a 16-bit CRC or a 32-bit CRC.

FIG. 3B illustrates the structure of a UWB PHY packet according to an embodiment of the disclosure.

Part (a) of FIG. 3B illustrates an exemplary structure of the UWB PHY packet to which an STS packet configuration is not applied, and part (b) of FIG. 3B illustrates an exemplary structure of the UWB PHY packet to which the STS packet configuration is applied. The UWB PHY packet may be referred to as a PHY packet, a PHY PDU (PPDU), or a frame.

Referring to part (a) of FIG. 3B, the PPDU may include a synchronization header (SHR), a PHY header (PHR), and a PHY payload (PSDU). The PSDU may include a MAC frame, and the MAC frame may include a MAC header (MHR), a MAC payload, and/or a MAC footer (MFR) as illustrated in FIG. 3A. The synchronization header part may be referred to as a preamble, and the part including the PHY header and the PHY payload may be referred to as a data part.

The synchronization header may be used for synchronization for signal reception and include a SYNC field and a start-of-frame delimiter (SFD).

The SYNC field may be a field including a plurality of preamble symbols used for synchronization between transmission/reception devices. The preamble symbol may be configured through one of predefined preamble codes.

The SFD field may be a field indicating the end of the SHR and the start of the data field.

The PHY header may provide information on a format of the PHY payload. For example, the PHY header may include information on the length of the PSDU, information indicating whether the current frame is a RFRAME (or data frame), and the like.

Meanwhile, the PHY layer of the UWB device may include an optional mode for providing reduced on-air time for high density/low-power operation. In this case, the UWB PHY packet may include a ciphered sequence (that is, STS) for increasing integrity and accuracy of the ranging measurement timestamp. The STS may be included in the STS field of the UWB PHY packet and may be used for security ranging.

Referring to part (b) of FIG. 3B, when the STS packet (SP) configuration is 0 (SP0), the STS field is not included in the PPDU (SP0 packet). When the SP configuration is 1 (SP1), the STS field is located right after the start-of-frame delimiter (SFD) field and before the PHR field (SP1 packet). In the case of SP configuration 2 (SP2), the STS field is located after the PHY payload (SP2 packet). In the case of SP configuration 3, the STS field is located right after the SFD field, and the PPDU does not include the PHR and the data field (PHY payload) (SP3 packet). That is, in the case of SP3, the PPDU does not include the PHR and the PHY payload.

As illustrated in part (b) of FIG. 3B, each UWB PHY packet may include a RMARKER for defining the reference time, and the RMARKER may be used to acquire a transmission time, a reception time, and/or a time interval of a ranging message (frame) during a UWB ranging procedure.

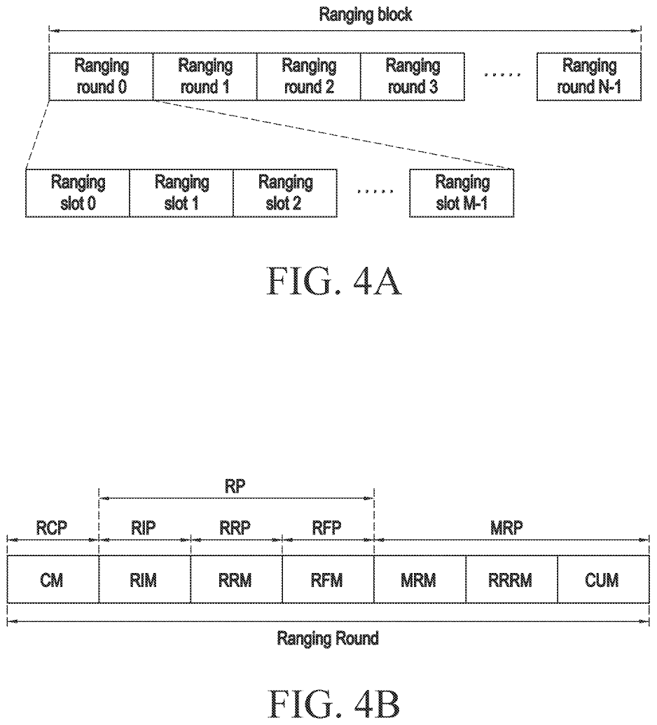

FIG. 4A illustrates an example of a ranging block structure according to an embodiment of the disclosure. FIG. 4B illustrates an example of a ranging round according to an embodiment of the disclosure.

Referring to FIG. 4A, one ranging block may include at least one ranging round, and each ranging round may include at least one ranging slot. For example, as illustrated, one ranging block may include N ranging rounds (for example, ranging round 0 to ranging round N-1), and ranging round #0 may include M ranging slots (for example, ranging slot 0 to ranging slot M).

The ranging block refers to a time period for ranging. The ranging round may be a period of sufficient duration for completing one entire range-measurement cycle (ranging cycle) in which a set of UWB devices participating in ranging exchange involves. A ranging slot may be a sufficient period for transmitting at least one ranging frame (RFRAME) (for example, ranging initiation/response/final message).

Meanwhile, when the ranging mode is a block-based mode, a mean time between consecutive ranging rounds may be a constant. Alternatively, when the ranging mode is an interval-based mode, a time between consecutive ranging rounds may be dynamically changed. That is, the interval-based mode may adopt a time structure having adaptive spacing.

The ranging block may be abbreviated as a block, the ranging round may be abbreviated as a round, and the ranging slot may be abbreviated as a slot.

Referring to FIG. 4B, one ranging round may include a ranging control phase (RCP), a ranging phase (RP), and/or a measurement report phase (MRP). For example, one ranging round may include one slot for the RCP, at least one slot for the RP, and/or at least one slot for the MRP.

According to an embodiment, some of the above-described phases may not be included in the ranging round, and additional phases may be further included in the ranging round. For example, the RCP may not be included in the ranging round. In this case, the ranging control message (RCM) may be integrated with a ranging initiation message (RIM). For example, a ranging control update phase (RCUP) and/or a ranging interval update phase (RIUP) may be further included in the ranging round.

The RCP may be a phase in which the controller transmits the RCM. The RCM may be a message transmitted by the controller to configure ranging parameters. In an embodiment, the RCM may be transmitted in a first slot (slot #0) of the ranging round. The RCM may be abbreviated as a control message (CM).

The RP may be a phase including a ranging initiation phase (RIP), a ranging response phase (RRP), and/or a ranging final phase (RFP).

The RIP may be a phase in which initiator(s) transmit RIM(s) to responder(s).

The RRP may be a phase in which responder(s) transmit their own ranging response message(s) (RRM(s)) to the initiator.

The RFP may be a phase in which the initiator transmits ranging final message(s) (RFM(s)) to responder(s). The ranging final phase may be used only for the DS-TWR.

The MRP may be a phase in which participating ranging devices exchange service information related to ranging measurement. In the MRP, a measurement report message (MRM), a ranging result report message (RRRM), and/or a control update message (CUM) may be transmitted. The MRM may be a message transmitted by the UWB device to exchange measurement information. The RRRM may be a message transmitted by the UWB device to report the ranging result. The CUM may be a message transmitted by the controller to update control information. The CUM may be referred to as a control update message (ranging control update message (RCUM)).

The RCUP may be a phase in which the controller transmits the ranging control update message (RCUM). The ranging control update phase may be included in the last slot of the set of ranging rounds designated by the RCM. The RCUM may be a message transmitted by the controller to update ranging parameters for the following ranging round(s). The RCUM may be transmitted in the last slot of ranging round(s) designated by the RCM. The RCUM may include some or all of information elements (IEs) employed by the RCM in order to update values of the parameters.

The ranging interval update phase (RIUP) may be a phase in which the controller transmits a ranging interval update message (RIUM). The RIUM may be a message transmitted by the controller to help for synchronization between participating ranging devices or update an interval between ranging blocks. The RIUM includes a scheduled time of the first RIUM. The RIUM may include a scheduled time of the next RIUM before the next ranging block starts.

As necessary, the plurality of UWB messages may be integrated into one message. For example, the RCM may be integrated with the RIM and transmitted during the RIP. For example, in the case of non-deferred DS-TWR, the RFM may be integrated with the MRM and transmitted during the RFP.

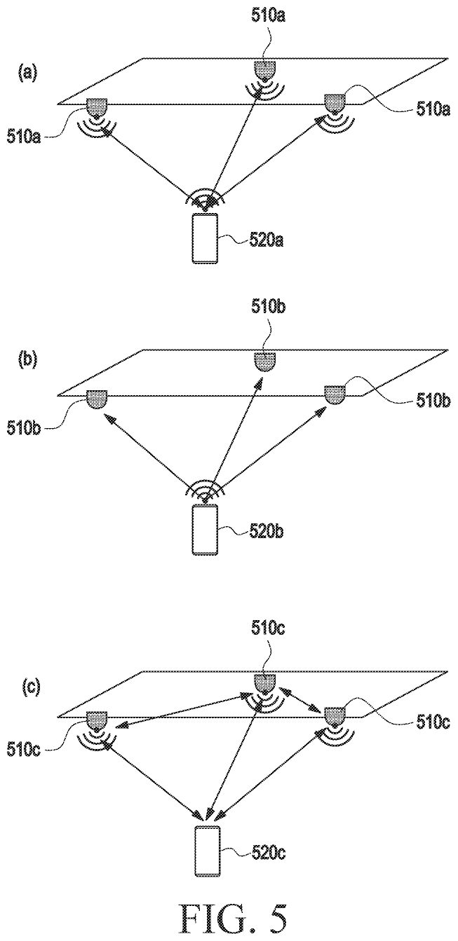

FIG. 5 illustrates various examples of a UWB ranging method according to an embodiment of the disclosure.

Part (a) of FIG. 5 illustrates an example of a two way ranging (TWR) method, part (b) of FIG. 5 illustrates an example of a uplink TDoA (UL-TDoA) method that is one type of the OWR, and part (c) of FIG. 5 illustrates an example of a downlink TDoA (DL-TDoA) method that is one type of the OWR.

Referring to part (a) of FIG. 5, a UWB device 520a of the user may perform ranging with at least one UWB anchor 510a through ranging exchange using a plurality of ranging messages. Through such ranging exchange (ranging message exchange), the time of flight (ToF) may be calculated and the distance between two devices may be estimated.

The UWB device 520a may perform single-sided two-way ranging (SS-TWR) or double-sided two-way ranging (DS-TWR) with the UWB anchor 510a. When performing the TWR, the UWB device 520a may serve as an initiator or a responder.

In an embodiment, the TWR may be performed according to a hybrid-based mode, a contention-based mode, and/or a scheduling-based mode.

Referring to part (b) of FIG. 5, the UWB device (UWB tag) 520a of the user may transmit or broadcast a ranging message, and at least one UWB anchor 510b may acquire TDoA, based on the received ranging message and estimate the location of the UWB device 520b, based on TDoA.

Referring to part (c) of FIG. 5, the UWB device (UWB tag) 520c of the user may receive ranging message transmitted/received between at least one UWB anchor 510c and estimate its own location. The user device 520c performing the DL-TDoA may overhear messages transmitted by two anchor devices and calculate the TDoA that is proportional to the difference in the distance between each anchor device and the user device. The user device 520c may calculate the distance relative to anchor devices by using the TDoA with several pairs of anchor devices and use the same for positioning.

The disclosure proposes various embodiments for the UWB-based service. Hereinafter, for convenience of description, various embodiments of the disclosure are described on the basis of assumption that the UWB-based service is a kiosk service using the UWB (for example, a kiosk service using UWB pointing), but are not limited thereto. For example, various embodiments of the disclosure may be applied to the UWB-based service using an electronic device performing the same or similar function as or similar to the kiosk.

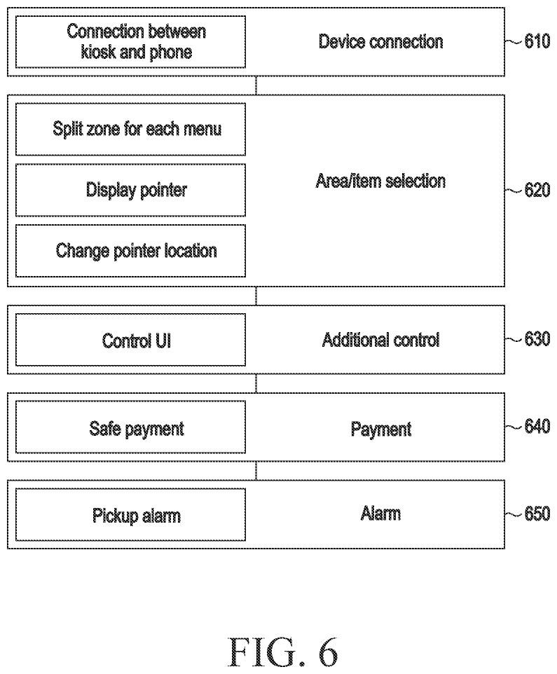

FIG. 6 illustrates an example of a procedure for providing the UWB-based service according to an embodiment of the disclosure.

Referring to FIG. 6, the procedure for providing the UWB-based service (UWB-based service providing procedure) may include at least one of the following operations.
Operation 610 (device connection operation): operation 610 may be an operation for a connection (for example, a UWB session connection) between a user device (for example, a mobile phone) and a kiosk. As an embodiment, one or a plurality of user devices may be simultaneously connected to one or a plurality of kiosks.
Operation 620 (area/item selection operation): operation 620 may be an operation in which the user device selects a specific area (or a specific item) on the display provided by the kiosk. The specific area (or the specific item) may be associated with a menu provided by the kiosk. As an embodiment, the kiosk may provide zones split according to each menu on the display. As an embodiment, the kiosk may display a pointer at a reference location or a reference area on the display. As an embodiment, the kiosk may display a pointing location of the user device. For example, when the pointing location of the user device is changed, the kiosk may change the pointing location on the display. That is, the kiosk may display the changed pointing location on the display.
Operation 630 (additional control operation): operation 630 may be an operation for performing additional control for providing the UWB-based service. The kiosk and/or the user device may provide at least one control UI for the additional control. For example, the kiosk may provide the user device with a control UI through a touch screen, a control UI for inputting a gesture, and/or a control UI through a keypad. As an embodiment, the additional control may include, for example, control for selecting a menu, control for selecting the number of selected menus, control for moving a page, and control for payment.
Operation 640 (payment operation): operation 640 may be an operation for performing secure payment between the user device and the kiosk.
Operation 650 (alarm operation): operation 650 may be an operation in which the kiosk provides an alarm to the user device. For example, the kiosk may provide the user device with an alarm for picking up the ordered menu.

Meanwhile, according to an embodiment, some operations illustrated in FIG. 6 may be omitted or additional operations may be further included. Further, the operations may be performed in the order different from the order illustrated in FIG. 6.

In the disclosure, the user device may be referred to as a first device, a first electronic device, or a first UWB device, and the kiosk device may be referred to as a second device, a second electronic device, or a second UWB device.

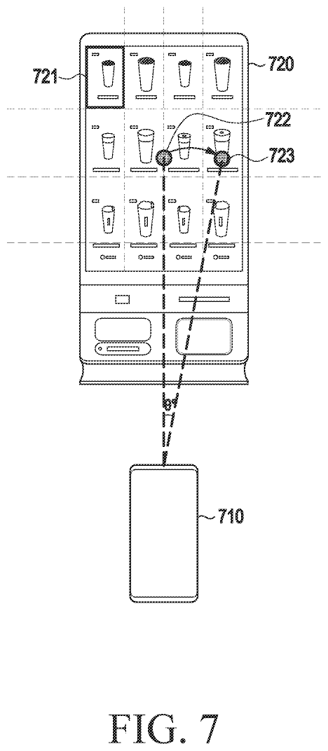

FIG. 7 illustrates an example of a scenario of providing the UWB-based service using UWB pointing according to an embodiment of the disclosure.

In the embodiment of FIG. 7, for convenience of description, it is illustrated that one user device 710 is connected to one kiosk 720, but is not limited thereto.

Referring to FIG. 7, in order to use the UWB-based service provided by the kiosk 720, the user device 710 may perform a device connection operation (for example, operation 610 of FIG. 6). Accordingly, a UWB session may be established between the user device 710 and the kiosk 720.

In order to select a specific area or item provided by the kiosk, the user device 710 may perform an area/item selection operation (for example, operation 620 of FIG. 6).

As an embodiment, the kiosk 720 may configure and provide separate zones for each of a plurality of menus. For example, as illustrated in FIG. 7, a first menu may be displayed through a first zone 721 on the display of the kiosk 720.

As an embodiment, the kiosk 720 may display a pointer (reference pointer) at a reference location or a reference area on the display. For example, the reference pointer may be displayed at a preset reference location 722 (for example, the center of the display of the kiosk 720).

As an embodiment, the user device 710 may point the pointer displayed at the reference location 722. For example, the user device 710 may point the pointer displayed at the first location 722 by using UWB pointing function. Accordingly, the intention of the user device 710 (or the user of the user device 710) to use the UWB-based service provided by the kiosk 720 may be identified.

As an embodiment, the user device 710 may point a location 723 different from the reference location 722. For example, the user device 710 may point the location 723 to select a menu associated with a zone including the location 723.

The user device 710 may perform an additional control operation (for example, operation 630 of FIG. 6) to additionally control the selected menu. For example, the user device 710 may decide the number of selected menus by using at least one additional control UI provided by the kiosk 720 and perform the additional control for making payment.

Thereafter, the user device 710 and the kiosk 720 may perform a payment operation (for example, operation 640 of FIG. 6) and/or an alarm operation (for example, operation 650 of FIG. 6).

As described above, according to the disclosure, since the service can be selected/controlled using the UWB pointing function, the kiosk service may be provided in a non-contact type.

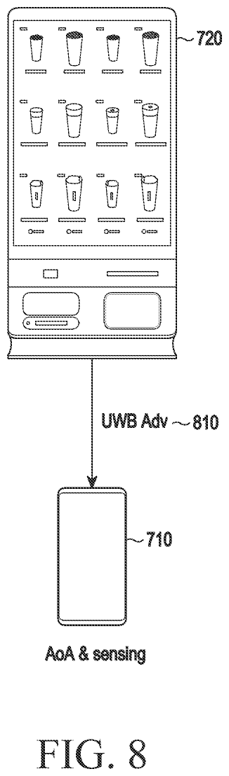

FIG. 8 illustrates an example of a procedure for UWB pointing according to an embodiment of the disclosure.

Referring to FIG. 8, the kiosk 720 may transmit or broadcast a UWB advertisement message 810. For example, the kiosk 720 may periodically broadcast the UWB advertisement message 810.

As an embodiment, the UWB advertisement message 810 may be a UWB OWR message having a type of advertisement message. For example, the UWB advertisement message 810 may be a UWB OWR message having a type of advertisement message for AoA measurement (AoA advertisement message). As an embodiment, the UWB advertisement message 810 may be used for OWR for AoA measurement.

The user device 710 may perform OWR for AoA measurement by using the UWB advertisement message 810. For example, the UWB advertisement message 810 may be received and AoA measurement for the UWB advertisement message 810 may be performed. Accordingly, the user device 710 may acquire AoA azimuth information and/or AoA elevation information. As an embodiment, when the horizontal axis (horizontal display axis) on the display of the kiosk 720 is set as the x axis, the vertical axis (vertical display axis) on the display of the kiosk 720 is set as the y axis, and the axis orthogonal to the display of the kiosk 720 is set as the z axis, the AoA azimuth information (value) may be a relative angle between the Z axis and a received signal including the UWB advertising message 810 projected on the XZ plane, and the AoA elevation information (value) may be a relative angle between the XZ plane and the received signal including the UWB advertising message 810 In the disclosure, the AoA azimuth information may be referred to as horizontal axis angle information, and the AoA elevation information may be referred to as vertical axis angle information.

Meanwhile, when the user device 710 has sufficient UWB antennas for AoA measurement, the user device 710 may acquire both the horizontal axis angle information (for example, AoA azimuth information) and the vertical axis angle information (for example, AoA elevation information) through the OWR for AoA measurement. However, when the user device 710 does not have sufficient UWB antennas for AoA measurement (for example, has only one UWB antenna or three or less UWB antennas), the user device 710 may acquire only one angle information between the horizontal axis angle information (for example, AoA azimuth information) and the vertical axis angle information (for example, AoA elevation information). In this case, in order to accurately control the UWB-based pointing, a method of supplementing/calibrating the angle information may need to be considered. For example, when only the horizontal axis angle information (for example, AoA azimuth information) is acquired through AoA measurement using the UWB advertisement message 810, a method of acquiring the vertical axis angle information may need to be considered. Alternatively, when only the vertical axis angle information (for example, AoA elevation information) is acquired through AoA measurement using the UWB advertisement message 810, a method of acquiring the horizontal axis angle information may need to be considered.

As an embodiment, the user device 710 may supplement/calibrate the angle information by using sensing information. For example, the user device 710 may calibrate the angle information by using sensing information of an inertial measurement unit (IMU) sensor. For example, when only the horizontal axis angle information is acquired through AoA measurement, the user device 710 may acquire the vertical axis angle information by using sensing information of the IMU sensor. Alternatively, when only the vertical axis angle information is acquired through AoA measurement, the user device 710 may acquire the horizontal axis angle information by using sensing information of the IMU sensor.

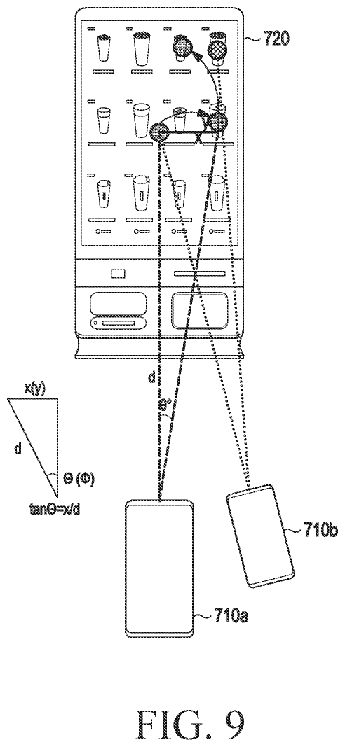

FIG. 9 illustrates an example of a method by which the user device selects an item by using a UWB pointing function according to an embodiment of the disclosure.

Referring to FIG. 9, a method by which the user device selects an item by using a UWB pointing function (item selection method) may include at least one of the following procedures.

### (1) Reference Location Pointing Procedure

The user device 710a may point a reference location (for example, the reference location 722 of FIG. 7).

The user device 710a pointing the reference location (or the pointer displayed at the reference location) may perform OWR (for example, OWR for AoA measurement) and/or TWR (for example, SS-TWR or DS-TWR for measuring the distance to the kiosk 720) with the kiosk 720.

### OWR for AoA Measurement

The user device 710a may receive a UWB advertisement message (for example, the UWB advertisement message 810 of FIG. 8) broadcasted from the kiosk 720 and perform AoA measurement (or OWR for AoA measurement) for the advertisement message. Accordingly, the user device 710a may acquire horizontal axis angle information (θ) and/or vertical axis angle information (Φ) for the reference location.

When one of the horizontal axis angle information (θ) or the vertical axis angle information (Φ) is acquired through AoA measurement, the user device 710a may acquire the remaining angle information by using sensing information (for example, sensing information of the IMU sensor). For example, when only the horizontal axis angle information (θ) is acquired through AoA measurement, the user device 710a may acquire the vertical axis angle information (Φ) by using sensing information of the IMU sensor. Alternatively, when only the vertical axis angle information (Φ) is acquired through AoA measurement, the user device 710a may acquire the horizontal axis angle information (θ) by using sensing information of the IMU sensor.

### TWR for Distance Measurement

The kiosk 720 (or the user device 710a) may acquire information on the distance (distance information, d) between the user device 710a and the kiosk 720 by performing TWR (for example, SS-TWR or DS-TWR) with the user device 710a. As an embodiment, the user device 710 may operate as an initiator (and/or a controller) for TWR and the kiosk 720 may operate as a responder (and/or a controlee), but they are not limited thereto. For example, the kiosk device 720 may operate as the initiator (and/or the controller) for TWR and the user device 710 may operate as the responder (and/or the controlee) for TWR. Meanwhile, when only the user device 710a acquires the distance information (d), the user device 710a may transmit the distance information (d) to the kiosk 720.

### Identify User Intention

The user device 710a may identify a user's intention to use the UWB-Substitute based service provided by the kiosk 720 by using the acquired horizontal axis angle information (θ), vertical axis angle information (Φ), and/or distance information (d). For example, when a value of the distance information (d) is within a preset distance (for example, 5 meters) and a value of the horizontal axis angle information (θ) is within a preset angle range (for example, −5 degrees to +5 degrees), the user device 710a may identify that is a user's intention to use the UWB-based service provided by the kiosk 720. In another example, when a value of the distance information (d) is within a preset distance (for example, 5 meters), a value of the horizontal axis angle information (θ) is within a preset angle range (for example, −5 degrees to +5 degrees), and a value of the vertical axis angle information (Φ) is within a preset angle range (for example, −5 degrees to +5 degrees), the user device 710a may identify that there is a user's intention to use the UWB-based service provided by the kiosk 720.

When it is identified that there is the user's intention, the user device 710a may perform a subsequent operation. For example, the user device 710a may transmit the horizontal axis angle information (θ) and the vertical axis angle information (Φ) to the kiosk 720.

### Identify Pointing Location

The kiosk 720 may identify the location at which the user device 710a points by using the horizontal axis angle information (θ), the vertical axis angle information (Φ), and the distance information (d).

As an embodiment, the kiosk 720 may acquire horizontal axis distance information (x) from the reference location to the pointing location by using the horizontal axis angle information (θ) and the distance information (d). The horizontal axis distance information (x) may be calculated by Equation 1 below.

x=d tan θ Equation 1

As an embodiment, the kiosk 720 may acquire vertical axis distance information (y) from the reference location to the pointing location by using the vertical axis angle information (Φ) and the distance information (d). The vertical axis distance information (y) may be calculated by Equation 2 below.

y=d tan Φ Equation 2

As an embodiment, the kiosk 720 may identify the location (pointing location) at which the user device 710 points by using the horizontal axis distance information (x) and the vertical axis distance information (y). For example, the kiosk 720 may calculate the pointing location by using the reference location, the horizontal axis distance information (x), and the vertical axis distance information (y).

The kiosk 720 may display a pointer at the pointing location.

### (2) Selection Item Location Pointing Procedure

The user device 710a may point a location of an item to be selected (selection item location) (for example, the location 723 of FIG. 7).

The user device 710a that points at the selection item location may perform OWR (for example, OWR for AoA measurement) with the kiosk 720 and/or TWR (for example, SS-TWR or DS-TWR) for distance measurement with the kiosk 720). Accordingly, the kiosk 720 may identify the location (pointing location) at which the user device 710 points. Description for OWR for AoA measurement, TWR for distance measurement, and identification of the pointing location for the selection item location pointing procedure may refer to the description of the OWR for AoA measurement, the TWR for distance measurement, and the identification of the pointing location for the reference location pointing procedure.

The kiosk 720 may identify whether the item is selected based on the identified pointing location. For example, when the identified pointing location is within an area related to the item, the kiosk 720 may identify that the corresponding item is identified.

When the item is selected, the kiosk 720 may perform the following operation (for example, operation 630 or 640 of FIG. 6) with the user device 720a.

When the item is not selected, the kiosk 720 may perform again the selection item location pointing procedure with the user device 720a.

Meanwhile, as illustrated in FIG. 9, a plurality of user devices 710a and 710b may be connected to one kiosk 720. In this case, procedures for the item selection method may be performed for each user device. For example, an operation that is the same as or similar to the operation performed by the first user device 710a may be performed by the second user device 710b.

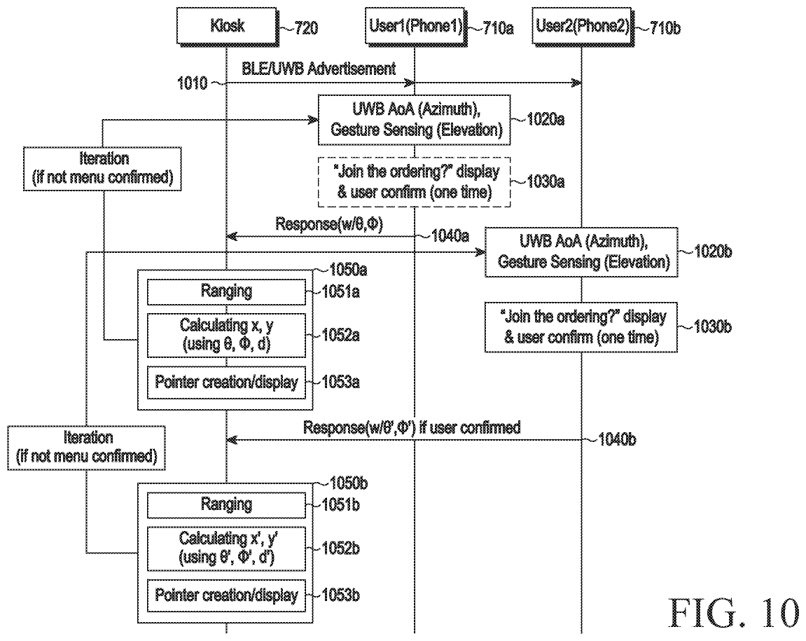

FIG. 10 is a flowchart illustrating a method by which the user device selects an item by using a UWB pointing function according to an embodiment of the disclosure.

FIG. 10 may be an example of operation 620 of FIG. 6 or the item selection method of FIG. 9.

Referring to FIG. 10, the item selection method may include at least one of the following operations.
Operation 1010: the kiosk 720 may transmit or broadcast a BLE advertisement message and/or a UWB advertisement message. Transmission/broadcasting of the BLE advertisement message may be an optional operation.

As an embodiment, the kiosk 720 may periodically broadcast the BLE advertisement message in order to discover a service and/or a device. The user devices 710a and 710b may discover a service and/or device for the kiosk 720, based on the BLE advertisement message. When the UWB communication module is turned off, the user devices 710a and 710b may switch on the UWB communication module, based on the BLE advertisement message being received.

As an embodiment, the kiosk 720 may periodically broadcast a UWB advertisement message (for example, the UWB advertisement message 810 of FIG. 8) for AoA measurement. The user devices 710a and 710b may perform OWR for AoA measurement by using the UWB advertisement message.
Operation 1020a: the user device 710a may receive a UWB advertisement message (for example, the UWB advertisement message 810 of FIG. 8) broadcasted from the kiosk 720 and perform AoA measurement (or OWR for AoA measurement) for the advertisement message. Accordingly, the user device 710a may acquire horizontal axis angle information (θ) or vertical axis angle information (Φ) for the reference location.

When only one of the horizontal axis angle information (θ) or the vertical axis angle information (Φ) is acquired through AoA measurement, the user device 710a may acquire the remaining angle information by using sensing information (for example, sensing information of the IMU sensor). For example, when only the horizontal axis angle information (θ) is acquired through AoA measurement, the user device 710a may acquire the vertical axis angle information (Φ) by using sensing information of the IMU sensor. Alternatively, when only the vertical axis angle information (Φ) is acquired through AoA measurement, the user device 710a may acquire the horizontal axis angle information (θ) by using sensing information of the IMU sensor.

The user device 710a may identify a user's intention to use the UWB-based service provided by the kiosk 720 by using the acquired horizontal axis angle information (θ) and/or the vertical axis angle information (Φ). For example, when a value of the horizontal axis angle information (θ) is within a preset angle range (for example, −5 degrees to +5 degrees), the user device 710a may identify that there is the user's intention to use the UWB-based service provided by the kiosk 720. In another example, when a value of the horizontal axis angle information (θ) is within a preset angle range (for example, −5 degrees to +5 degrees) and a value of the vertical axis angle information (Φ) is within a preset angle range (for example, −5 degrees to +5 degrees), the user device 710a may identify that the user intention to use the UWB-based service provided by the kiosk 720.

When it is identified that there is the user intention to use the UWB-based service provided by the kiosk 720, the user device 710a may perform a subsequent operation.
Operation 1030a: the user device 710a may display information for asking the user for an intention of “join the ordering” and receive user confirmation therefor. Operation 1030a is an optional operation and may be omitted. Alternatively, operation 1030a may be provided only one when it is identified that there is the user's intention to use the UWB-based service provided by the kiosk 720.
Operation 1040a: the user device 710a may transmit the horizontal axis angle information (θ) and the vertical axis angle information (Φ) to the kiosk 720. When it is identified that there is the user's intention to use the UWB-based service provided by the kiosk 720, the user device 710a may transmit a response including the horizontal axis angle information (θ) and the vertical axis angle information (Φ) to the kiosk 720. As an embodiment, the response including the horizontal axis angle information (θ) and the vertical axis angle information (Φ) may be transmitted while being included in a UWB message (for example, RIM, RRM, or RRF) for TWR.

Operation 1050a: operation 1050a may be an operation (item selection operation) performed by the kiosk 720 and the user device 710a in order to select at least one of the items (for example, menus) provided by the kiosk 720. As an embodiment, in operation 1050a, the kiosk 720 may perform ranging operation 1051a, pointing location calculation operation 1052a, and/or pointer generation/display operation 1053a. Description of each operation may be made below.
a) Ranging operation 1051a: the kiosk 720 may acquire information (distance information, d) on the distance between the user device 710a and the user device 720 by performing TWR (for example, SS-TWR or DS-TWR) with the user device 710a.

As an embodiment, the user device 710a may operate as an initiator (and/or a controller) for TWR and the kiosk 720 may operate as a responder (and/or a controlee). In this case, the user device 710 may transmit an RIM for initiating TWR. As an embodiment, the RIM may include horizontal axis angle information (θ) and vertical axis angle information (Φ). The kiosk 720 may transmit an RRM to the user device 710a in response to the RIM. When SS-TWR is used, the user device 710a may calculate ToF, based on the RIM and the RRM, and calculate distance information between the user device 710a and the kiosk 720, based on the ToF. In this case, the user device 710a may transmit the distance information (d) to the kiosk 720. When DS-TWR is used, the user device 710a may transmit an RFM to the kiosk 720 in response to the RRM. In this case, the kiosk 720 may calculate distance information between the user device 710a and the kiosk 720, based on the RIM, the RRM, and the RFM. As an embodiment, the RFM may include distance information calculated by the user device 710a.

As an embodiment, the kiosk device 720 may operate as the initiator (and/or the controller) for TWR and the user device 710a may operate as the responder (and/or the controlee) for TWR. In this case, the kiosk 720 may transmit an RIM for initiating TWR. The user device 720a may transmit an RRM to the kiosk 720 in response to the RRM. As an embodiment, the RRM may include horizontal axis angle information (θ) and vertical axis angle information (Φ). When SS-TWR is used, the kiosk 720 may calculate ToF, based on the RIM and the RRM, and calculate distance information between the user device 710a and the kiosk 720, based on the ToF. When DS-TWR is used, the kiosk 720 may transmit an RFM to the user device 710a in response to the RRM.
b) Pointing location calculation operation 1052a: the kiosk 720 may identify the location at which the user device 710a points by using horizontal axis angle information (θ), vertical axis angle information (Φ), and distance information (d).

As an embodiment, the kiosk 720 may acquire horizontal axis distance information (x) from the reference location to the pointing location by using the horizontal axis angle information (θ) and distance information (d₁). The horizontal axis distance information (x) may be calculated by Equation 1 described above.

As an embodiment, the kiosk 720 may acquire vertical axis distance information (y) from the reference location to the pointing location by using the vertical axis angle information (Φ) and the distance information (d). Vertical axis distance information (y) may be calculated by Equation 2 described above.

As an embodiment, the kiosk 720 may identify the location (pointing location) at which the user device 710 points by using the horizontal axis distance information (x) and the vertical axis distance information (y). For example, the kiosk 720 may calculate the pointing location by using the reference location, the horizontal axis distance information (x), and the vertical axis distance information (y).
c) Pointer generation/display operation 1053a: the kiosk 720 may generate a pointer and display the pointer at the pointing location.

The kiosk 720 may determine whether the item (for example, menu) is selected/confirmed based on the pointing location. For example, when the identified pointing location is within an area related to the item, the kiosk 720 may identify that the corresponding item is identified.

When the menu is not confirmed, operations 1020a to 1050a may be performed again. For example, operations 1020a to 1050a may be repeatedly performed until the menu is confirmed. At this time, operation 1030a may be omitted as described above.

Meanwhile, when the plurality of user devices 710a and 710b receives a BLE/UWB advertisement message (for example, the BLE/UWB advertisement message in operation 1010) from the kiosk 720, a procedure that is the same as or similar to the procedure of operations 1020a to 1050a for the first user device 710a may be performed by the second user device 710b. For example, operation 1020b that is the same as operation 1020a may be performed by the second user device 710b, operation 1030b that is the same as operation 1030a may be performed by the second user device 710b, and operation 1050b that is the same as operation 1050a may be performed by the second user device 710b. For the description of operations 1020b to 1050b, refer to the description of operations 1020a to 1050a made above.

In an embodiment, operation 1040b for the second user device 710b may be performed only when the user confirmation is received in operation 1030b. In this case, the operation of displaying information for asking the user about the intention of “join the ordering” and receiving the user confirmation therefor in operation 1040b may be an operation that must be provided once, and only when the user confirmation is received, the second user device 710b may provide horizontal axis angle information (θ′) and/or vertical axis angle information (Φ′) for the second user device 710b acquired in operation 1020b to the kiosk 720. Meanwhile, in the following procedure, operation 1030b may be omitted like operation 1030a.

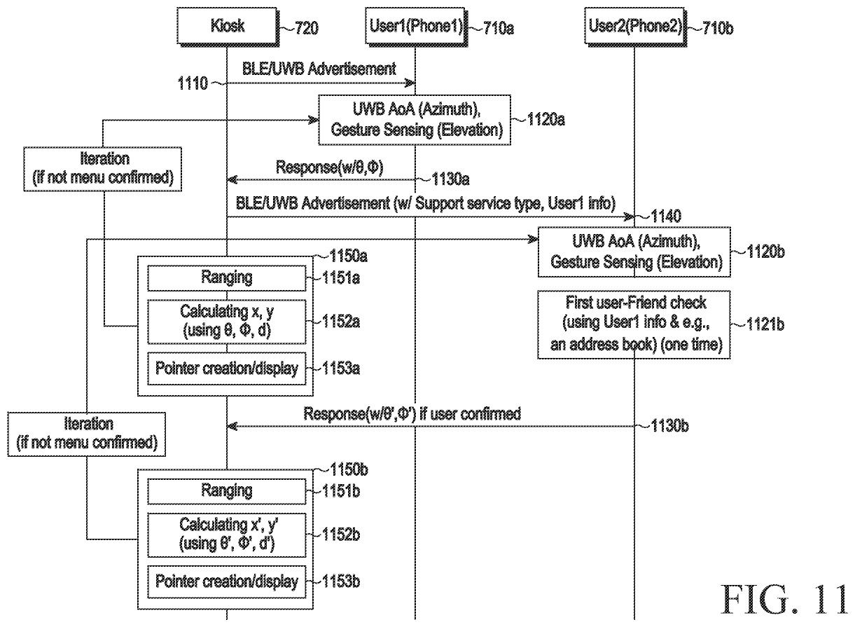

FIG. 11 is a flowchart illustrating a method by which the user device selects an item by using a UWB pointing function according to an embodiment of the disclosure.

FIG. 11 may be an example of operation 620 of FIG. 6 or the item selection method of FIG. 9.

Referring to FIG. 11, the item selection method may include at least one of the following operations.
Operation 1110: operation 1110 of FIG. 11 is the same as operation 1010 of FIG. 10 and may refer to the description of operation 1010 of FIG. 10.
Operation 1120a: operation 1120a of FIG. 11 is the same as operation 1020a of FIG. 10 and may refer to the description of operation 1020a of FIG. 10.
Operation 1130a: operation 1130a of FIG. 11 is the same as operation 1040a of FIG. 10 and may refer to the description of operation 1040a of FIG. 10.

Meanwhile, in addition to the user of the first user device 710a, it may be necessary to additionally connect the second user device 710b to the kiosk 720. For example, when the user of the second user device 710a is associated with the user of the first user device 710a (for example, an acquaintance), it may be necessary to additionally connect the second user device 710b to the kiosk 720 during item/menu selection of the first user device 710a. To this end, operation 1140 may be performed.
Operation 1140: the kiosk 720 may transmit or broadcast a BLE advertisement message and/or a UWB advertisement message.

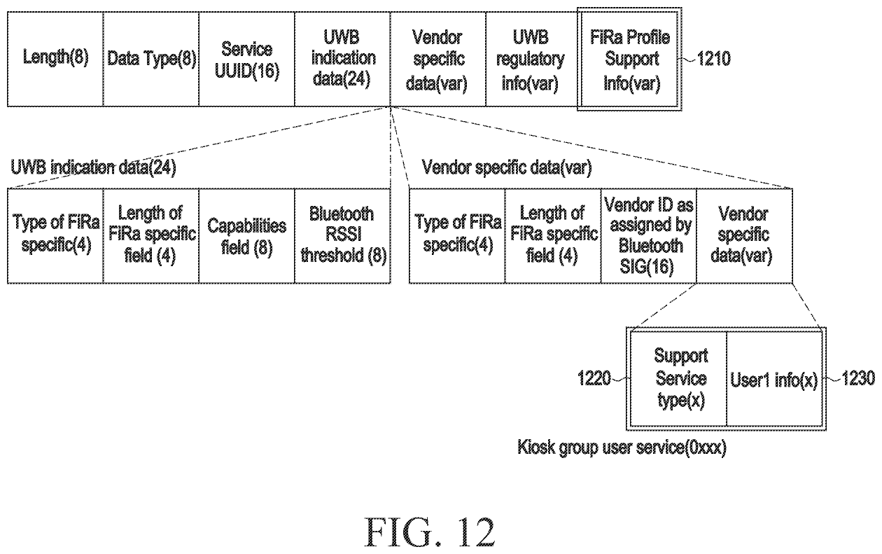

The BLE advertisement message of operation 1140 may be a BLE advertisement message different from the BLE advertisement message of operation 1110. In the disclosure, the BLE advertisement message of operation 1110 may be referred to as a first BLE advertisement message, and the BLE advertisement message of operation 1140 may be referred to as a second BLE advertisement message. As an embodiment, the second BLE advertisement message may include support service type information and/or first user (user1) information. An example of the second BLE advertisement message is described below with reference to FIG. 12.

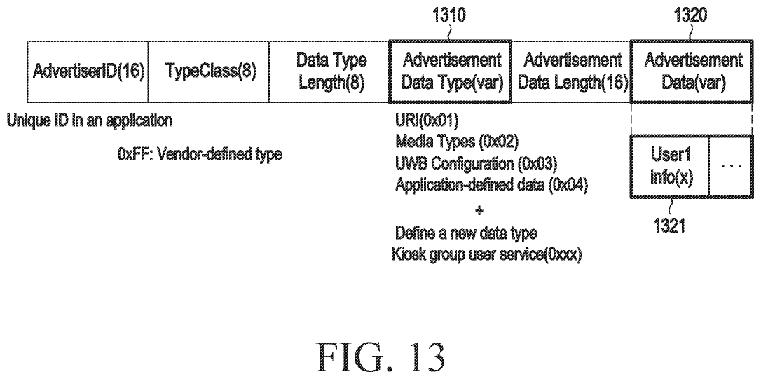

The UWB advertisement message of operation 1140 may be a UWB advertisement message different from the UWB advertisement message of operation 1110. In the disclosure, the UWB advertisement message of operation 1110 may be referred to a first UWB advertisement message, and the UWB advertisement message of operation 1140 may be referred to as a second UWB advertisement message. As an embodiment, the second UWB advertisement message may include support service type information and/or first user (user1) information. An example of the second UWB advertisement message is described below with reference to FIG. 13.

Operation 1150a: operation 1150a and operations 1151a/1152a/1153a of FIG. 11 are the same as operation 1050a and operations 1051a/1052a/1053a of FIG. 10, respectively, and may refer to operation 1050a and operations 1051a/1052a/1053a of FIG. 10, respectively.

The kiosk 720 may determine whether the item (for example, menu) is selected/confirmed based on the pointing location.

When the menu is not confirmed, operations 1120a to 1150a may be performed again. For example, operations 1120a to 1105a may be repeatedly performed until the menu is confirmed.

Meanwhile, when the second user device 710b receives the second BLE advertisement message (for example, the BLE advertisement message in operation 1140) and/or the second UWB advertisement message (for example, the UWB advertisement message in operation 1140) from the kiosk 720, the second user device 710b may perform operation 1120b.

In operation 1120b, the second user device 710b may perform AoA measurement for the second UWB advertisement message. AoA measurement for the second UWB advertisement message in operation 1120b may be the same as AoA measurement for the first UWB advertisement message in operation 1120a. Further, when only one of the horizontal axis angle information (θ′) or the vertical axis angle information (Φ′) is acquired through AoA measurement, the second user device 710b may acquire the remaining angle information by using sensing information (for example, sensing information of the IMU sensor). The operation of acquiring the remaining angle information in operation 1120b may be the same as the operation of acquiring the remaining angle information in operation 1120a. Further, in operation 1120b, the second user device 710b may identify a user's intention to use the UWB-based service provided by the kiosk 720 by using the acquired angle information. The operation of identifying the user's intention in operation 1120b may be the same as the operation of identifying the user's intention in operation 1120a. When the user's intention is identified, the second user device 710b may perform operation 1121b.

In operation 1121b, the second user device 710b may determine whether it is required to additionally connect the second user device 710b to the kiosk 720 to which the first user device 710a is connected based on the second BLE advertisement message or the second UWB advertisement message. For example, the second user device 710a may identify whether the kiosk 720 to which the first user device 710a is connected needs the additional connection, based on the support service type information and the first user information included in the second BLE advertisement message or the second UWB advertisement message. For example, when it is identified that the kiosk 720 supports a kiosk group user service by using the support service type information and there is association with the first user device 710a currently connected to the kiosk 720 (for example, whether it has a family or acquaintance relationship with the user of the first user device 710a or whether has had a connection to the kiosk 720 together with the first user device 710a) by using the first user information, the second user device 710a may identify that it is required to additionally connect the second user device 710b to the kiosk 720 to which the first user device 710a is connected.

When it is identified that it is not required to additionally connect the second user device 710b, the second user device 710b may transmit the horizontal axis angle information (θ′) and vertical axis angle information (Φ′) acquired in operation 1120b to the kiosk 720 in operation 1130b. Transmission of the horizontal axis angle information (θ′) and the vertical axis angle information (Φ′) in operation 1130b may be the same as transmission of the horizontal axis angle information (θ) and the vertical axis angle information (Φ) in operation 1130a.

Thereafter, the second user device 710b may perform operation 1150b. Operation 1150b and operations 1151b/1152b/1153b may refer to the description of operation 1151a and operations 1151a/1152a/1153a, respectively.

FIG. 12 illustrates an example of a BLE advertisement message according to an embodiment of the disclosure.

The BLE advertisement message of FIG. 12 may be used to provide information for the connection of an additional user device (for example, used in operation 1140 of FIG. 11), but is not limited thereto. For example, the BLE advertisement message of FIG. 12 may be used for various procedures of the disclosure that requires the use of the BLE advertisement message.

Referring to FIG. 12, the BLE advertisement message may include a length field, a data type field, a service UUID field, a UWB indication data field, a vendor-specific data field, a UWB regulatory information (info) field, and/or a FiRa profile support information (info) field 1210.

The UWB indication data field may include a field indicating a type of the FiRa-specific field, a field indicating the length of the FiRa-specific field, a capability field, and/or a field indicating a Bluetooth relative signal strength indication (RSSI) threshold.

The vendor-specific data field may include a field indicating a type of the FiRa-specific field, a field indicating the length of the FiRa-specific field, a field indicating a vendor ID such as allocation by a Bluetooth SIG, and/or a data field 1510 including vendor-specific data.

As an embodiment, the FiRa profile support information field 1210 may provide information on a supported service (or service profile). For example, when the supported service is a kiosk service, the FiRa profile support information field 1210 may be configured as a value that designates the kiosk service (or a profile of the kiosk service).

As an embodiment, the vendor-specific data field (or BLE advertisement message) may include a support service type field 1220 and/or a user information field 1230. For example, the support service type field 1220 and/or the user information field 1230 may be included in a data field within the vendor-specific data field. In the disclosure, the user information field 1230 may be referred to as first user information (user 1 info.) field.

The support service type field 1220 may designate a type of the supported service. The support service type field 1220 may be used to distinguish detailed purposes of the supported service. For example, when the service (or service profile) designated by the FiRa profile support information field 1210 is the kiosk service (or the profile of the kiosk service), the support service type field 1220 may designate the type of the kiosk service. For example, the support service type field 1220 may be configured as a value (for example, 0x05) that designates a kiosk group user service.

As described above, when the FiRa profile support information field 1210 and the support service type field 1220 are used together, a service in a large range may be designated through the FiRa profile support information field 1210 and a detailed purpose of the corresponding service may be designated through the support service type field 1220.

The user information field 1230 may provide information on the currently connected user device (for example, the first user device 710a of FIG. 11) or the user of the corresponding user device. For example, the user information field 1230 may include information for identifying the user device currently connected to the kiosk or the user of the corresponding user device (for example, a MAC address of the corresponding user device, international mobile equipment identity (IMEI), a phone number, or the like).

The user device (for example, the second user device 710b of FIG. 11) receiving the BLE advertisement message may determine whether there is association with the user device (for example, the first user device 710a of FIG. 11) currently connected to the kiosk by using information included in the user information field 1230. For example, when it is identified that the second user device 710b has an acquaintance relationship or a family relationship with the user of the first user device 710a by using information included in the user information field 1230, the second user device 710b may determine that the first user device 710a and the second user device 710b are associated with each other. For example, when it is identified that the second user device 710b has been connected to the kiosk 710 together with the first user device 710a by using information included in the user information field 1230, the second user device 710b may determine that the first user device 710a and the second user device 710b are associated with each other.

When it is identified that there is association, the user device (for example, the second user device 710b of FIG. 11) receiving the BLE advertisement message may identify that an additional connection to or control of the kiosk is required. When it is identified that the additional connection to or the control of the kiosk is required, the user device may transmit horizontal axis angle information and vertical axis angle information (for example, the horizontal axis angle information and vertical axis angle information acquired in operation 1120b of FIG. 11) to the kiosk 720. Accordingly, the procedure for item selection (for example, the procedure of operation 1150b of FIG. 11) may be performed by the kiosk and the corresponding user device.

FIG. 13 illustrates an example of a UWB advertisement message according to an embodiment of the disclosure.

The UWB advertisement message of FIG. 13 may be used to provide information for the connection of an additional user device (for example, used in operation 1140 of FIG. 11), but is not limited thereto. For example, the UWB advertisement message of FIG. 13 may be used for various procedures of the disclosure that require the use of the UWB advertisement message.

Referring to FIG. 13, the UWB advertisement message may include an advertiser ID (AdvertiserID) field, a type class (TypeClass) field, a data type length field, an advertisement data type field, an advertisement data length field, and/or an advertisement data field.

The AdvertiserID field may indicate an identification (ID) of an application that provides a service.

The TypeClass field indicates a class of data included in the advertisement data field. The TypeClass field may be configured as one of a value (for example, 0x01) indicating a URI, a value (for example, 0x02) indicating a media type, a value (for example, 0x03) indicating a UWB configuration, a value (for example, 0x04) indicating application-defined data, or a value (0xFF) indicating a vendor-defined type.

The data type length field indicates the length of the advertisement data type field.

The advertisement data type field 1310 indicates a detailed data type for a part defined in the TypeClass field.

For example, when the TypeClass field is configured as the value (for example, 0x01) indicating the URI, the advertisement data type field 1310 may designate a detailed type of the URI (for example, absolute URI or the like).

When the TypeClass field is configured as the value (for example, 0x02) indicating the media type, the advertisement data type field 1310 may designate a detailed type of the media type (for example, text, image, audio, or the like).

When the TypeClass field is configured as the value (for example, 0x03) indicating the UWB configuration, the advertisement data type field 1310 may designate a detailed type of the UWB configuration.

When the TypeClass field is configured as the value (for example, 0x04) indicating the application-defined data, the advertisement data type field 1310 may designate a detailed type of the application-defined data.

When the TypeClass field is configured as the value (0xFF) indicating the vendor-defined type, the advertisement data type field 1310 may designate a detailed type of the vendor-defined type. For example, when the kiosk service having the type of the kiosk group user service is supported, the advertisement data type field 1310 may be configured as a value (for example, 0x05) indicating that the data type of the vendor-defined type is a data type for the kiosk group user service.

The advertisement data length field indicates the length of the advertisement data field.

The advertisement data field 1320 includes data to be advertised. The advertisement data field 1320 may include a user information field 1321. In the disclosure, the user information field 1321 may be referred to as first user information (user 1 info.) field.

The user information field 1321 may provide information 1321 on the currently connected user device (for example, the first user device 710a of FIG. 11) or the user of the corresponding user device. For example, the user information field 1230 may include information for identifying the user device currently connected to the kiosk or the user of the corresponding user device (for example, a MAC address of the corresponding user device, IMEI, a phone number, or the like).

The user device (for example, the second user device 710b of FIG. 11) receiving the BLE advertisement message may determine whether there is association with the user device (for example, the first user device 710a of FIG. 11) currently connected to the kiosk. For example, when it is identified that the second user device 710b has an acquaintance relationship or a family relationship with the user of the first user device 710a by using information included in the user information field 1230, the second user device 710b may determine that the first user device 710a and the second user device 710b are associated with each other. For example, when it is identified that the second user device 710b has been connected to the kiosk 710 together with the first user device 710a by using information included in the user information field 1230, the second user device 710b may determine that the first user device 710a and the second user device 710b are associated with each other.

When it is identified that there is association, the user device (for example, the second user device 710b of FIG. 11) receiving the BLE advertisement message may identify that an additional connection to or control of the kiosk is required. When it is identified that the additional connection to or the control of the kiosk is required, the user device may transmit horizontal axis angle information and vertical axis angle information (for example, the horizontal axis angle information and vertical axis angle information acquired in operation 1120b of FIG. 11) to the kiosk 720. Accordingly, the procedure for item selection (for example, the procedure of operation 1150b of FIG. 11) may be performed by the kiosk and the corresponding user device.

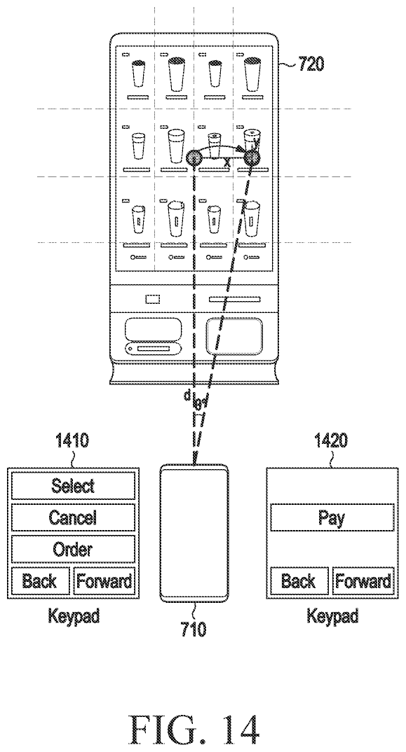

FIG. 14 illustrates an example of a method by which the user device controls an order by using a UWB pointing function according to an embodiment of the disclosure.

Referring to FIG. 14, a method by which the user device 710 controls an order by using a UWB pointing function (an order control method) may include at least one of the following procedures.

### (1) Reference Location Pointing Procedure

The user device 710 may point at a reference location (for example, the first location 722 of FIG. 7). For example, the user device 710 may identify a user's intention by performing the reference location pointing procedure of FIG. 9.

### (2) Selection Item Location Pointing Procedure

The user device 710 may select a kiosk item by using the UWB pointing function. For example, the user device 710 may select a kiosk item by performing the selection item location pointing procedure of FIG. 9.

### (3) Additional Control Procedure

The user device 710 may perform additional control by using a control UI. As an embodiment, the user device 710 may perform additional control by using a control UI through a keypad. For example, a first control UI 1410 or a second control UI 1420 may be displayed on the user device 710 through the keypad, and the user device may perform additional control through the displayed control UIs.

As an embodiment, the first control UI 1410 may include items (for example, control buttons/keys) for controlling select, cancel, order, back, and/or forward. The second control UI 1420 may include items for controlling (for example, control buttons/keys) pay, back, and/or forward.

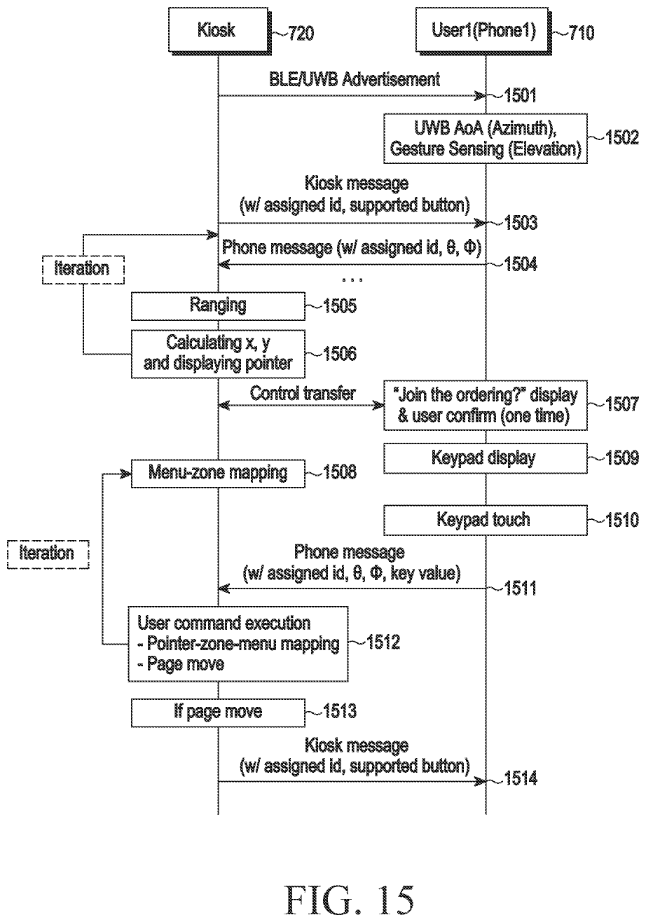

FIG. 15 is a flowchart illustrating a method by which the user device controls a kiosk order by using a UWB pointing function.

FIG. 15 may be an example of operation 630 of FIG. 6 or the order control method of FIG. 14.

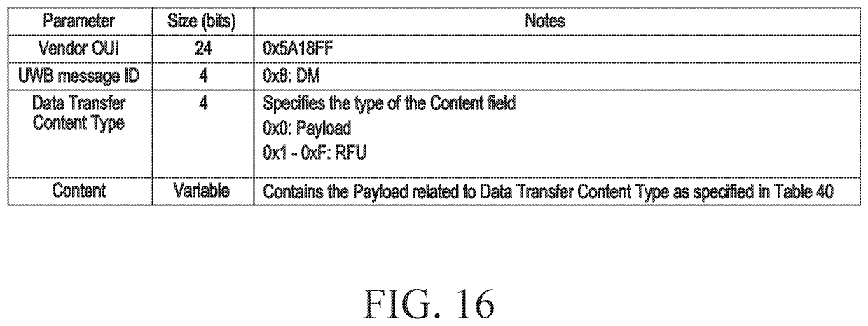

Referring to FIG. 15, the order control method may include at least one of the following operations.
Operation 1501: operation 1501 of FIG. 15 may be an operation that is the same as operation 1010 of FIG. 10, operation 1110 of FIG. 11, or operation 1140 of FIG. 11, and may refer to the corresponding description.
Operation 1502: operation 1502 of FIG. 15 may be an operation that is the same as operation 1020a of FIG. 10, operation 1020b of FIG. 10, operation 1120a of FIG. 11, or operation 1120b of FIG. 11, and may refer to the corresponding description.
Operation 1503: the kiosk 720 may transmit a first kiosk message to the user device 710. As an embodiment, the first kiosk message may be a UWB message (for example, a UWB data message). As an embodiment, the first kiosk message may include assigned ID information and/or supported button information for the current screen or page. An example of the kiosk message is described below with reference to FIGS. 16, 17, and 19.
Operation 1504: the user device 710 may transmit a first phone message to the kiosk 1720. As an embodiment, the first phone message may be a UWB message (for example, a UWB data message). As an embodiment, the first phone message may include assigned ID information, horizontal axis angle information (θ), and/or vertical axis angle information (Φ).
Operation 1505: operation 1505 of FIG. 15 may be an operation that is the same as operation 1051a of FIG. 10, operation 1051b of FIG. 10, operation 1151a of FIG. 11, or operation 1151b of FIG. 11, and may refer to the corresponding description.
Operation 1506: operation 1506 of FIG. 15 may be an operation that is the same as operation 1052a/1053a of FIG. 10, operation 1052b/1053b of FIG. 10, operation 1152a/1153a of FIG. 11, or operation 1152b/1153b of FIG. 11.
Operation 1507: the user device 710 may display information for asking the user about an intention of “join the ordering” and receive user confirmation therefor. When the user confirmation is received, the user device 710 may transmit information on the user confirmation to the kiosk 720. Operation 1507 may be an optional operation.
Operation 1508: the kiosk 720 may determine whether menus and zones are mapped by using operation 1506 and the result of operation 1506. That is, the kiosk 720 may determine whether a menu is selected based on a pointing location acquired through operation 1506 and the result of operation 1506.
Operation 1509: the user device 710 may display a keypad (or a control UI of the keypad). The control UI of the keypad may be, for example, the first control UI 1410 of FIG. 14 or the second control UI 1420 of FIG. 14.
Operation 1510: the user device 710 may acquire an input (for example, a touch input) for the keypad (or the control UI of the keypad).
Operation 1511: the user device 710 may transmit a second phone message to the kiosk 720. As an embodiment, the second phone message may be a UWB message (for example, a UWB data message). As an embodiment, the second Substitute Specification Clean Version phone message may include assigned ID information, horizontal axis angle information (θ), vertical axis angle information (Φ), and/or key value information. The key value information may correspond to the input of operation 1510.
Operation 1512: the kiosk 720 may execute a user command. As an embodiment, the kiosk 720 may execute a user command corresponding to the key value information. The user command may be, for example, a pointer-zone-menu mapping command or a page movement command. When the user command is the pointer-zone-menu mapping command, the user device may perform operation 1508 again.
Operation 1513: the kiosk 720 may determine whether the user command is the page movement command. When the user command is the page movement command, operation 1514 may be performed.
Operation 1514: the kiosk 720 may transmit a second kiosk message to the user device 710. As an embodiment, the second kiosk message may be a UWB message (for example, a UWB data message). As an embodiment, the second kiosk message may include assigned ID information and/or supported button information for the moved screen or page. Information included in the second kiosk message may be different from the information included in the first kiosk message.

FIG. 16 illustrates an example of a UWB message according to an embodiment of the disclosure.

The UWB message of FIG. 16 may be a UWB data message (data frame).

The UWB message of FIG. 16 may be the kiosk message of FIG. 15 (for example, the kiosk message of operation 1503 or the kiosk message of operation 1514) or the phone message of FIG. 15 (for example, the phone message of operation 1504 or the phone message of operation 1511).

Referring to FIG. 16, the UWB message may include a vendor OUI field, a UWB message ID field, a data transfer content type field, and/or a content field.

The vendor OUI field may designate an ID of the vendor.

The UWB message ID field may designate an ID of the UWB message. When the UWB message is the kiosk message or the phone message, the UWB message ID field may be configured as a value that designates a data message (DM).

The data transfer content type field may designate a type of the content field. When the UWB message is the kiosk message or the phone message, the data transfer content type field may be configured as a value indicates that the type of the content field is a payload type.

The content field may include content having a type designated by the data transfer content type field. For example, when the data transfer content type field indicates that the type of the content field is the payload type, the content field may include payload related to the data transfer content type field.

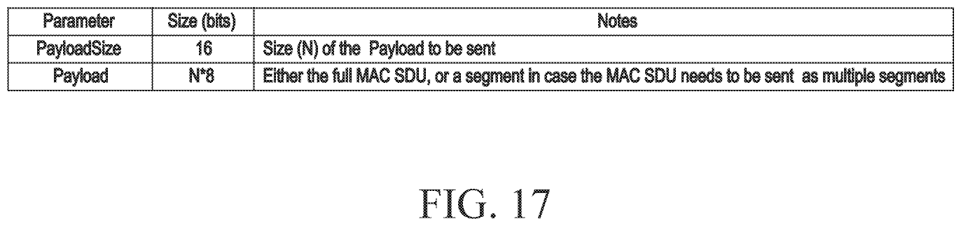

FIG. 17 illustrates an example of payload included in the content field of the UWB message of FIG. 16.

Referring to FIG. 17, the payload included in the content field may include a payload size field and/or a payload field.

The payload size field may designate the size of payload (or payload field) to be transmitted.

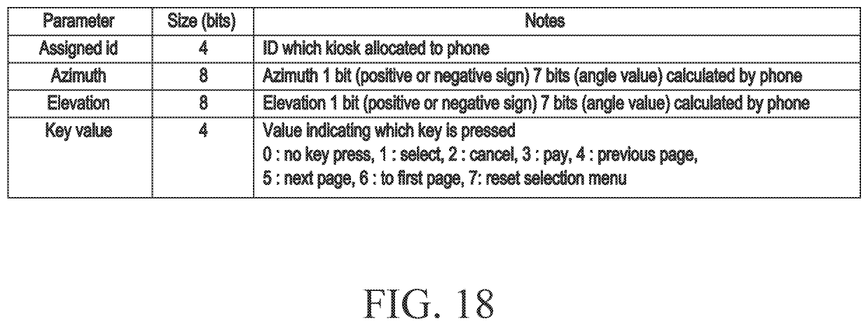

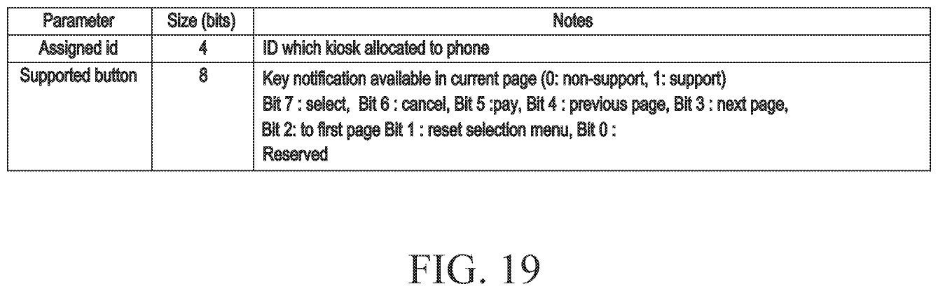

The payload field may include payload data. As an embodiment, when a full MAC SDU or a MAC SDU needs to be transmitted as multiple segments, the payload field may include segments. An example of the payload data included in the payload field may be the same as FIG. 18 or 19 to be described below.

FIG. 18 illustrates an example of the payload data included in the payload of FIG. 17.

The payload data of FIG. 18 may be an example of the payload data used for a phone message (for example, the phone message of operation 1504 or the phone message of operation 1511). As described above, the payload data may be fully included in the payload field within the payload or segmented and included therein according to a segmentation configuration.

Referring to FIG. 18, the payload data for the phone message may include an assigned ID field, an azimuth field, an elevation field, and/or a key value field. The azimuth field may be referred to as a horizontal axis angle field, and the evaluation field may be referred to as a vertical axis angle field.

The assigned ID field may include an ID of the user device (for example, phone) assigned by the kiosk.

The azimuth field may include AoA azimuth information (horizontal axis angle information) calculated by the user device (for example, phone). As an embodiment, the azimuth field is a 8-bit field where 1 bit may designate positive and negative signs of azimuth and 7 bits may designate an azimuth value.

The evaluation field may include AoA elevation information (vertical axis angle information) calculated by the user device (for example, phone). As an embodiment, the evaluation field is a 8-bit field where 1 bit may designate positive and negative signs of elevation and 7 bits may designate an elevation value.

The key value field may include information informing of a key (or button) input into the user device (for example, phone). As an embodiment, the key value field may be configured as one of a first value (for example, 0) indicating that there is no key press, a second value (for example, 1) indicating that a selection key is input, a third value (for example, 2) indicating that a cancellation key is input, a fourth value (for example, 3) indicating that a payment key is input, a fifth value (for example, 4) indicating that a previous page key is input, a sixth value (for example, 5) indicating that a next page key is input, a seventh value (for example, 6) indicating a key to go to the first age is input, or an eighth value (for example, 7) indicating that a key for resetting the selection menu is input, but is not limited thereto.

FIG. 19 illustrates an example of payload data included in the payload of FIG. 17 of the disclosure.

The payload data of FIG. 19 may be an example of payload data used for a kiosk message (for example, the kiosk message of operation 1503 or the kiosk message of operation 1514). As described above, the payload data may be fully included in the payload field within the payload or segmented and included therein according to a segmentation configuration.

Referring to FIG. 19, the payload data for the kiosk message may include an assigned ID field and/or a supported button field.

The assigned ID field may include an ID of the user device (for example, phone) assigned by the kiosk.

The supported button field may include information informing of keys that can be used in the current page. As an embodiment, the supported button field may indicate whether a key corresponding to the corresponding bit is supported or not supported in the current page through a value of 0 or 1. For example, non-support of the key corresponding to the corresponding bit may be indicated through the value of 0, and support of the key corresponding to the corresponding bit in the current page may be indicated through the value of 1.

As an embodiment, in the supported button field, Bit 7 specifies support/non-support of the selection key, Bit 6: specifies support/non-support of the cancellation key, Bit 5 specifies support/non-support of the payment key, Bit 4: specifies support/non-support of the previous page key, Bit 3 specifies support/non-support of the next page key, Bit 2: specifies support/non-support of the first page key, Bit 1 specifies support/non-support of the selection menu reset key, and Bit 0: reserved value, but is not limited thereto. For example, the non-support of the selection key may be indicated in the current page when the value of Bit 7 is configured as 0, the support of the selection key may be indicated in the current page when the value of Bit 7 is configured as 1.

Hereinafter, a method of providing a notification to the user device through an advertisement message by using information on the user device acquired by the kiosk during a payment operation. As described above, according to the method of providing the notification using the advertisement message of the disclosure, even if the user is not near a monitor displaying the completion of the order, the user may check the alarm of the completion of the order and receive the ordered menu.

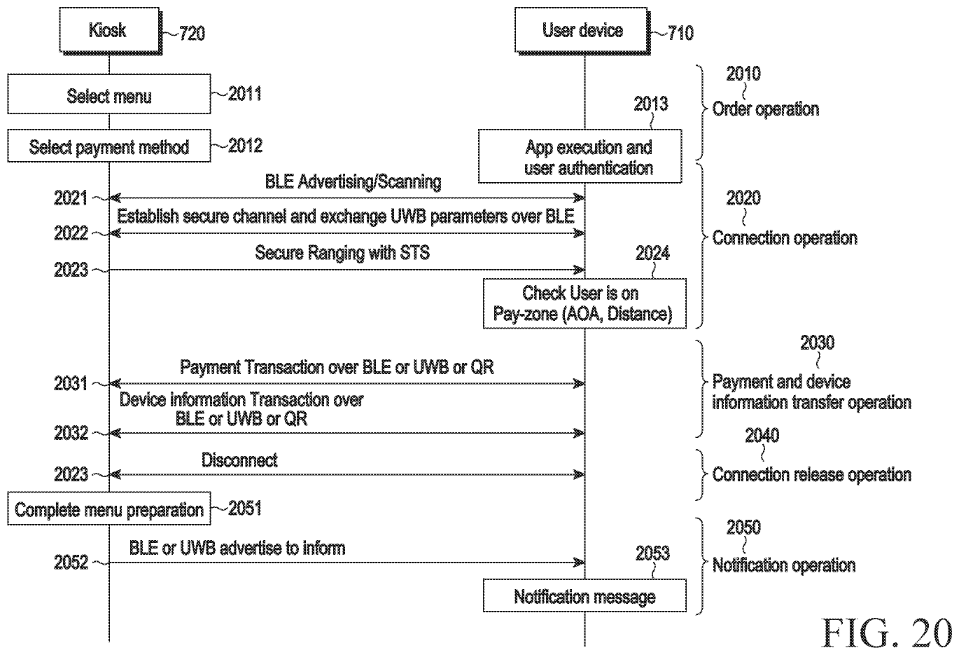

FIG. 20 illustrates an example of the method of providing the notification to the user device according to an embodiment of the disclosure. Referring to FIG. 20, the method of providing the notification to the user device (notification provision method) may include at least one of the following operations.
Operation 2010 (order operation): operation 2010 may be an operation for ordering a menu. As an embodiment, operation 2010 may include a menu selection operation 2011, a payment method selection operation 2012, and an app execution/user authentication operation 2013. Meanwhile, according to an embodiment, the payment method selection operation 2012 and the app execution/user authentication operation 2013 may be performed through a separate operation other than operation 2010.

The menu selection operation 2011 may be an operation in which the user selects a menu provided by the kiosk. As an embodiment, the menu selection operation 2011 may be performed using the procedure described in FIGS. 9 to 11.

The payment method selection operation 2012 may be an operation of selecting a payment method for payment of the selected menu. As an embodiment, the payment method may be a UWB payment method or a QR code payment method.

The app execution/user authentication operation 2013 may be an operation of executing an application for payment and performing user authentication.
Operation 2020 (connection operation): operation 2020 may be an operation for the connection of a UWB session. As an embodiment, operation 2020 may include a BLE advertisement/scanning operation 2021, a secure channel configuration and UWB parameter exchange operation 2022, a security ranging performance operation 2023, and/or a user's intention identification operation 2024. As an embodiment, operation 2020 may be omitted when the QR code payment method is selected as the payment method.

In the BLE advertisement/scanning operation 2021, the kiosk 720 may broadcast a BLE advertisement message, and the user device 710 may receive (or scan) the BLE advertisement message and discover a service and/or a device.

In the secure channel configuration and UWB parameter exchange operation 2022, the user device 710 and the kiosk 720 may establish a secure channel (for example, a BLE channel) through mutual authentication, and the user device 710 and the kiosk 720 may exchange UWB parameters for establishing a UWB session through the configured secure channel. Based on the exchanged UWB parameters, the UWB session between the user device 710 and the kiosk 720 may be established.

In the security ranging operation 2023, the user device 710 and the kiosk 720 may perform security ranging using the STS. As an embodiment, the procedure for configuring security ranging and the secure channel may be an optional procedure.

The user's intention identification operation 2024 may identify a user's intention for payment. As an embodiment, in the user's intention identification operation 2024, the user device 710 may determine whether the user device 710 (or user) is within a preset payment zone by using AoA information and distance information. When the user device 710 (or user) is within the preset payment zone, the user device 710 may identify that there is a user's intention for payment. Thereafter, the user device 710 may perform an operation for payment with the kiosk 720.
Operation 2030 (payment and device information transfer operation): operation 2030 may be an operation for transferring information for payment and device information. Operation 2030 may be an example of operation 640 of FIG. 6.

As an embodiment, operation 2030 may include a payment transaction operation 2031 for transferring payment information and a device information transaction operation 2032 for transferring device information. In the disclosure, payment information may include information required for payment (information necessary for payment) for the ordered menu. In the disclosure, the payment information may be referred to as payment required information.

The payment transaction operation 2031 may include an operation of transferring payment information through BLE communication, UWB communication, or another scheme (for example, QR code).

The payment transaction operation 2032 may include an operation of transferring device information through BLE communication, UWB communication, or another scheme (for example, QR code). As an embodiment, when the payment method is a UWB payment method, device information of the user device 710 may be transferred to the kiosk 720 through BLE communication or UWB communication. As an embodiment, when the payment method is a QR code payment method, device information of the user device 710 may be transferred to the kiosk 720 through the QR code. accordingly, the kiosk 720 may acquire the device information of the user device 710 to transmit a notification.

According to an embodiment, the payment transaction operation 2031 and the device information transaction operation 2032 may be performed as a single operation. For example, the payment information and the device information may be transferred together through BLE communication, UWB communication, or another scheme (for example, QR code).
Operation 2040 (connection release operation): operation 2040 may be an operation of releasing the connection of the UWB session. Operation 2040 may be an optional operation. For example, when the payment method is a QR code payment method, operation 2040 may be omitted.
Operation 2050 (notification operation): operation 2050 may be an operation in which the kiosk 720 provides a notification for the ordered menu to the user device 710. FIG. 10 may be an example of operation 650 of FIG. 6.

As an embodiment, operation 2050 may include operation 2051 in which the kiosk 720 identifies completion of menu preparation, operation 2052 in which the kiosk 720 transmits or broadcasts an advertisement message (for example, a BLE advertisement message or a UWB advertisement message) for the notification, and operation 2053 in which the user device 710 provides the notification (or notification message) to the user, based on the advertisement message.

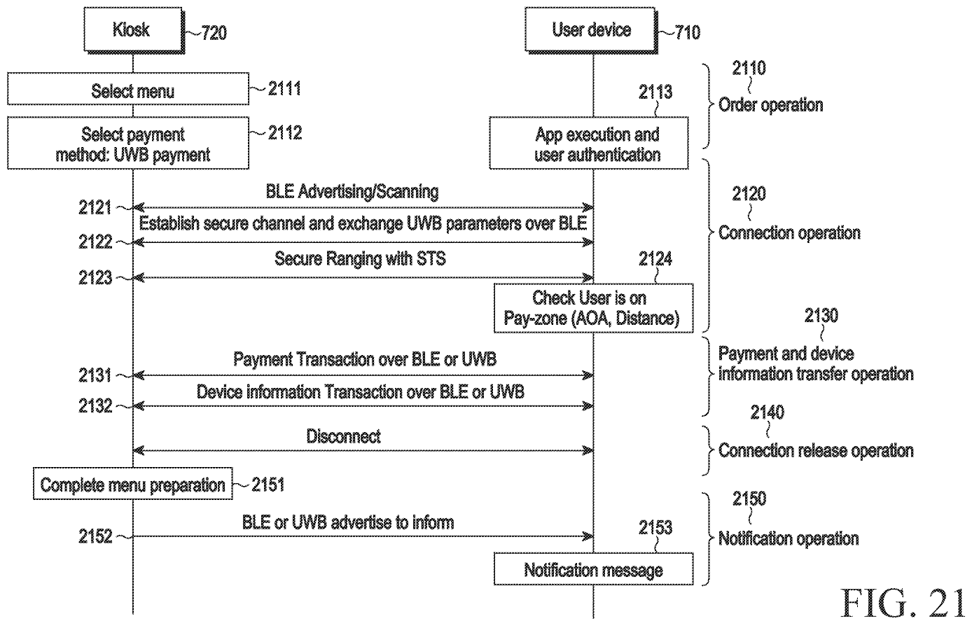

FIG. 21 illustrates an example of a method of providing a notification to the user device when a UWB payment method is used according to an embodiment of the disclosure.

The method of providing the notification to the user device (notification provision method) of FIG. 21 may be an example of the notification provision method of FIG. 20.

Referring to FIG. 21, when a UWB payment method is used, the notification provision method may include at least one of the following operations.
Operation 2110 (order operation): operation 2110 and operations 2111/2112/2113 of FIG. 21 may be the same as operation 2010 and operations 2011/2012/2013 of FIG. 20, respectively, and may refer to the corresponding description. Meanwhile, in the case of the embodiment of FIG. 21, the UWB payment method is selected in operation 2112.
Operation 2120 (connection operation): operation 2120 and operations 2121/2122/2123/2124 of FIG. 21 may be the same as operation 2020 and operations 2021/2022/2023/2024 of FIG. 20, respectively, and may refer to the corresponding description.
Operation 2130 (payment and device information transfer operation): operation 2130 and operations 2131/2132 of FIG. 21 may be the same as operation 2030 and operations 2031/2032 of FIG. 20, respectively, and may refer to the corresponding description. Meanwhile, in the case of the embodiment of FIG. 21, BLE communication or UWB communication is used to transfer device information of the user device 710 in operation 2132. For example, a BLE message or a UWB message may be used to transfer the device information of the user device 710.
Operation 2140 (connection release operation): operation 2140 of FIG. 21 may be the same as operation 2040 of FIG. 20, and may refer to the corresponding description.
Operation 2150 (notification operation): operation 2150 and operations 2151/2152/2153 of FIG. 21 may be the same as operation 2050 and operations 2051/2052/2053 of FIG. 20, respectively, and may refer to the corresponding description.

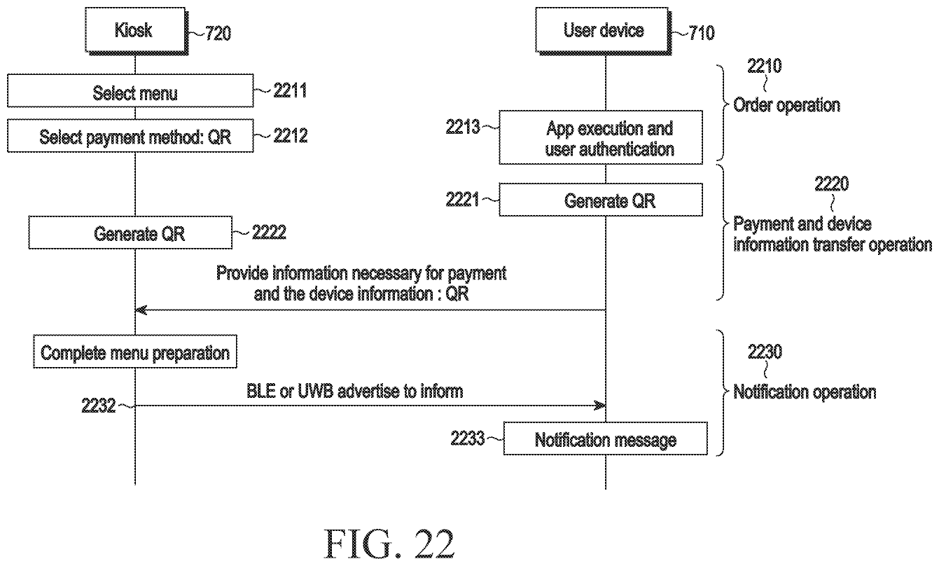

FIG. 22 illustrates an example of the method of providing the notification to the user device when the QR code payment method is used according to an embodiment of the disclosure.

The method of providing the notification to the user device (notification provision method) of FIG. 22 may be an example of the notification provision method of FIG. 20.

Referring to FIG. 21, when the QR code payment method is used, the notification provision method may include at least one of the following operations.
Operation 2210 (order operation): operation 2210 and operations 2211/2212/2213 of FIG. 22 may be the same as operation 2010 and operations 2011/2012/2013 of FIG. 20, respectively, and may refer to the corresponding description. Meanwhile, in the case of the embodiment of FIG. 22, the QR code payment method is selected in operation 2212.
Operation 2220 (payment and device information transfer operation): operation 2220 may include operation 2221 in which the user device 710 generates a QR code for providing payment information (information necessary for payment) and device information and operation 2222 in which the kiosk 720 acquires the payment information (information necessary for payment) and the device information by scanning the QR code. Accordingly, the payment information and the device information may be transferred to the kiosk 720.
Operation 2230 (notification operation): operation 2230 and operations 2231/2232/2233 of FIG. 22 may be the same as operation 2050 and operations 2051/2052/2053 of FIG. 20, respectively, and may refer to the corresponding description.

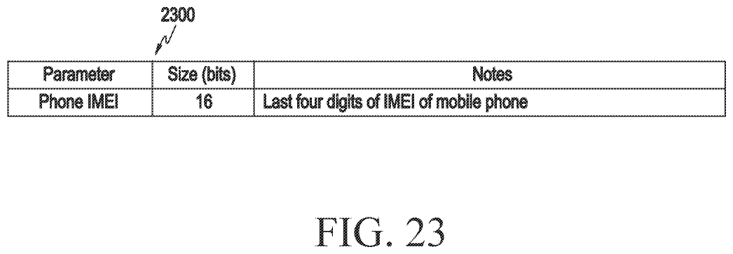

FIG. 23 illustrates an example of information elements including device information according to an embodiment of the disclosure.

Referring to FIG. 23, information elements 2300 may include device information. As an embodiment, the device information may include information on an IMEI of the user device (for example, phone). For example, the device information may include a value of the last four digits of the IMEI of the user device.

As an embodiment, the information elements 2300 including the device information may be transmitted through a UWB message (for example, the UWB message of FIG. 16) or a BLE message. For example, the information elements 2300 including the device information may be included in payload of the UWB message or the BLE message.

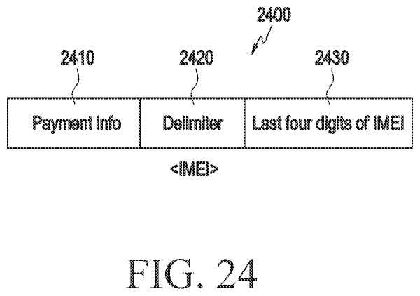

FIG. 24 illustrates another example of the information elements including the device information according to an embodiment of the disclosure.

Referring to FIG. 24, information elements 2400 may include payment information 2410, delimiter information 2420, and/or device information 2430. As an embodiment, the delimiter information 2420 may designate a delimiter of the device information, and the device information 2430 may include device information having the delimiter designated by the delimiter information. For example, the delimiter information 2420 may designate the IMEI of the user device (for example, phone), and the device information 2430 may include a value of the last four digits of the IMEI of the user device.

As an embodiment, the information elements 2400 including the device information may be included in a QR code (for example, the QR code generated by operation 2221 of FIG. 22). As described above, when the device information is transferred through the QR code, the payment information and the device information may be transferred together to the kiosk.

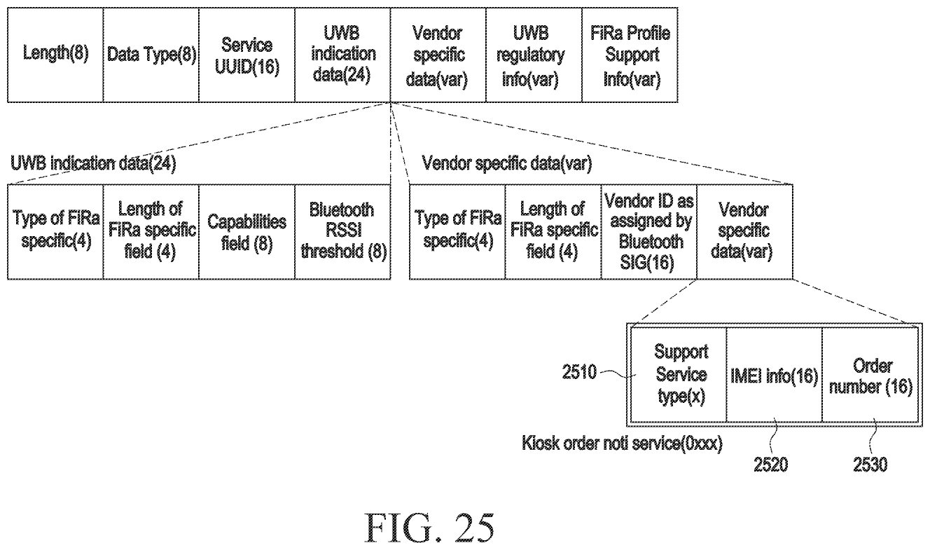

FIG. 25 illustrates an example of a BLE advertisement message according to an embodiment of the disclosure.

The BLE advertisement message of FIG. 25 may be used to provide a notification (used in operation 2052 of FIG. 20, operation 2152 of FIG. 21, or operation 2232 of FIG. 22), but is not limited thereto. For example, the BLE advertisement message of FIG. 25 may be used for various procedures of the disclosure that requires the use of the BLE advertisement message.

Referring to FIG. 25, the BLE advertisement message may include a length field, a data type field, a service UUID field, a UWB indication data field, a vendor-specific data field, a UWB regulatory information field, and/or a FiRa profile support information field 1210. Description for each field may refer to the description of FIG. 12.

As an embodiment, the vendor-specific data field (or BLE advertisement message) may include a support service type field 2510, IMEI information 2520, and/or an order number field 2530. For example, the service type field 2510, the IMEI information 2520, and/or the order number field 2530 may be included in a data field within the vendor-specific data field. In the disclosure, the IMEI information 2520 may be referred to as device information.

The support service type field 2510 may designate a type of the supported service. The support service type field 2510 may be used to distinguish detailed purposes of the supported service. For example, when the supported service is a kiosk order notification service, the support service type field 2510 may be configured as a value (for example, 0x06) that designates the kiosk order notification service.

The IMEI information 2520 may include device information. For example, the IMEI information 2520 may include a value of the last four digits of the IMEI of the user device. The user device may identify whether the corresponding BLE advertisement message is a BLE advertisement message for a notification for the user device itself by using the IMEI information 2520 included in the BLE advertisement message.

The order number field 2530 may include information on an order number. When it is identified that the corresponding BLE advertisement message is the BLE advertisement message for the notification for the user device itself, the user device may provide the user with the notification for the order number. Accordingly, the user may identify that his/her own order has been completed.

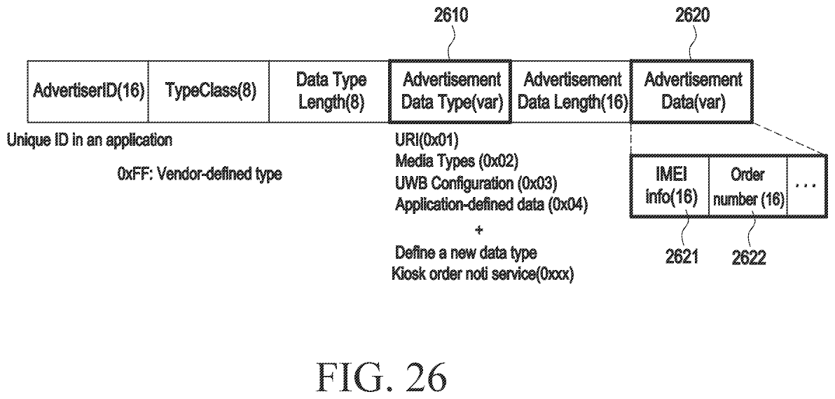

FIG. 26 illustrates an example of the UWB advertisement message according to an embodiment of the disclosure.

The UWB advertisement message of FIG. 26 may be used to provide a notification (for example, used in operation 2052 of FIG. 20, operation 2152 of FIG. 21, or operation 2232 of FIG. 22), but is not limited thereto. For example, the UWB advertisement message of FIG. 26 may be used for various procedures of the disclosure that require the use of the UWB advertisement message.

Referring to FIG. 26, the UWB advertisement message may include an advertiser ID (AdvertiserID) field, a type class (TypeClass) field, a data type length field, an advertisement data type field, an advertisement data length field, and/or an advertisement data field. Description for each field may refer to the description of FIG. 13.

The AdvertiserID field may indicate an identification (ID) of an application that provides a service. When the TypeClass field is configured as the value (0xFF) indicating the vendor-defined type, the advertisement data type field 2610 may designate a detailed type of the vendor-defined type. For example, when the kiosk order notification service is supported, the advertisement data type field 2610 may be configured as a value (for example, 0x06) indicating that the data type of the vendor-Substitute defined type is a data type for the kiosk order notification service.

The advertisement data field 2620 includes data to be advertised. The advertisement data field 2620 may include IMEI information 2621 and/or an order number field 2622. In the disclosure, the IMEI information 2621 may be referred to as device information field.

The IMEI information 2621 may include device information. For example, the IMEI information 2621 may include a value of the last four digits of the IMEI of the user device. The user device may identify whether the corresponding BLE advertisement message is a BLE advertisement message for a notification for the user device itself by using the IMEI information 2621 included in the BLE advertisement message.

The order number field 2622 may include information on an order number. When it is identified that the corresponding BLE advertisement message is the BLE advertisement message for the notification for the user device itself, the user device may provide the user with the notification for the order number. Accordingly, the user may identify that his/her own order has been completed.

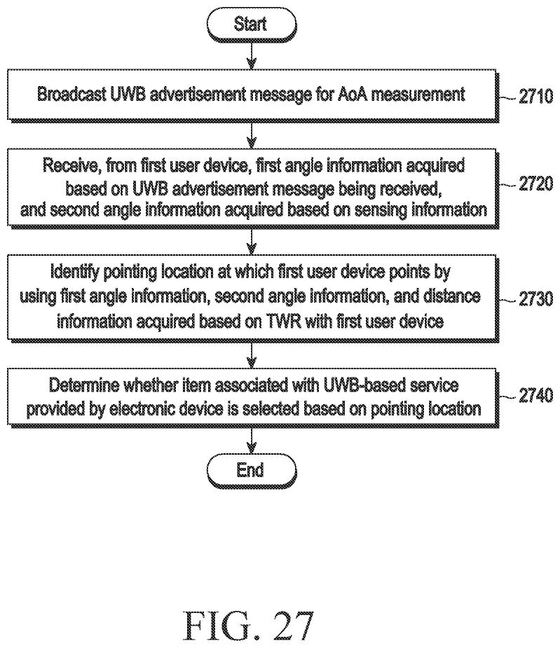

FIG. 27 illustrates a method of the user device according to an embodiment of the disclosure.

Referring to FIG. 27, the user device may receive a UWB advertisement message for AoA measurement in operation 2710.

The user device may acquire first angle information, based on the UWB advertisement message being received, and acquire second angle information, based on sensing information in operation 2720.

The user device may determine whether there is a user's intention to use a UWB-based service provided by an electronic device transmitting the UWB advertisement message, based on at least one of the first angle information and the second angle information.

When it is identified that there is the user's intention, the user device may transmit the first angle information and the second angle information to the electronic device in operation 2740.

As an embodiment, the first angle information and the second angle information may be used to identify a pointing location of the user device.

As an embodiment, the user device may transfer device information of the user device to the electronic device. As an embodiment, the user device may receive an advertisement message for notifying of completion of the order service related to a selected item, based on the pointing location. As an embodiment, the advertisement message may include the device information, type information indicating a type of the service supported through the advertisement message, and information for identifying the order service.

As an embodiment, the advertisement message may be a BLE advertisement message or a UWB advertisement message.

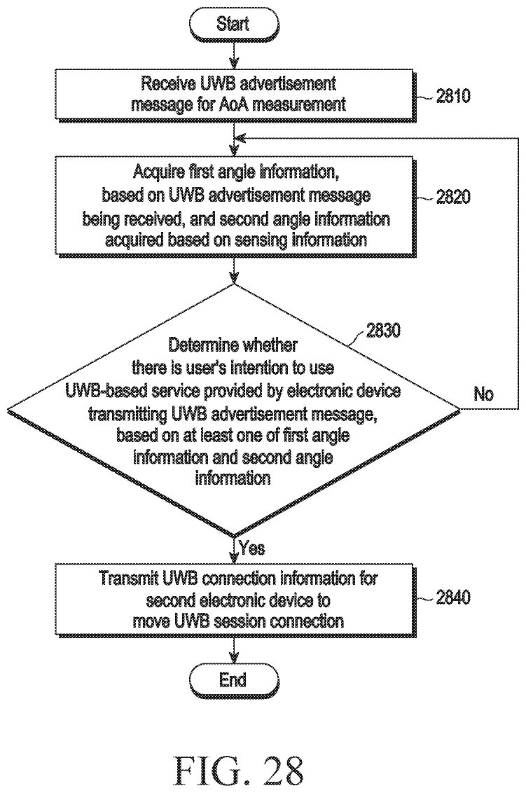

FIG. 28 illustrates a method of the kiosk according to an embodiment of the disclosure.

Referring to FIG. 28, the kiosk may broadcast a UWB advertisement message for AoA measurement in operation 2810.

The kiosk may receive the first angle information acquired based on the UWB advertisement message being received and the second angle information acquired based on sensing information in operation 2820.

The kiosk may identify the pointing location at which the first user device points by using the first angle information, the second angle information, and distance information acquired based on TWR with the first user device.

The kiosk may determine whether an item associated with the UWB-based service provided by the electronic device is selected based on the pointing location in operation 2840.

As an embodiment, the kiosk may broadcast a first advertisement message for supporting an additional connection of the second user device. The first advertisement message may include information on the first user device and type information indicating that a service supported through the advertisement message is a group user service. As an embodiment, the first advertisement message may be a BLE advertisement message or a UWB advertisement message.

When the item is selected, the kiosk may receive device information of the first user device from the first user device and broadcast a second advertisement message for notifying of completion of the order service related to the selected item, based on the pointing location. As an embodiment, the second advertisement message may include the device information, type information indicating that a service supported through the advertisement message is an order notification service, and information for identifying the order service.

As an embodiment, the first angle information may indicate a first angle horizontal to the screen of the electronic device, and the second angle information may indicate a second angle perpendicular to the screen of the electronic device.

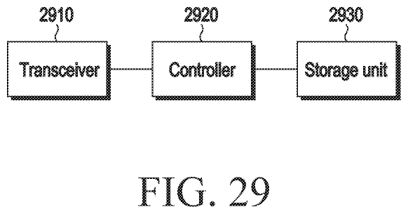

FIG. 29 illustrates a configuration of a UWB device according to an embodiment of the disclosure.

The UWB device may be a user device or a kiosk.

Referring to FIG. 29, the electronic device may include a transceiver 2910, a controller 2920, and a storage unit 2930. In the disclosure, the controller may be defined as a circuit, an application-specific integrated circuit, or at least one processor.

The transceiver 2910 may transmit and receive a signal to and from another entity. The transceiver 2910 may transmit and receive, for example, data for UWB ranging.

The controller 2920 may control the overall operation of the electronic device according to an embodiment proposed in the disclosure. For example, the controller 2920 may control a signal flow between blocks to perform the operation according to the above-described flowchart. Specifically, the controller 2920 may control, for example, the operation of the UWB device described with reference to FIGS. 1 to 28.

The storage unit 2930 may store at least one piece of information transmitted/received through the transceiver 2910 and information generated through the controller 2920. For example, the storage unit 2930 may store, for example, the information required for providing the UWB-based service described with reference to FIGS. 1 to 28.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method of an electronic device performing UWB communication, the method comprising:
broadcasting a UWB advertisement message for angle of arrival (AoA) measurement;
receiving, from a first user device, first angle information acquired based on the UWB advertisement message being received, and second angle information acquired based on sensing information;
identifying a pointing location, pointed by the first user device, by using the first angle information, the second angle information, and distance information acquired based on two-way ranging (TWR) with the first user device; and
determining whether an item associated with a UWB-based service provided by the electronic device is selected, based on the pointing location.

2. The method of claim 1, further comprising:
broadcasting a first advertisement message for supporting an additional connection of a second user device,
wherein the first advertisement message comprises information on the first user device and type information indicating that a service supported through an advertisement message is a group user service.

3. The method of claim 2, wherein the first advertisement message is a BLE advertisement message or a UWB advertisement message.

4. The method of claim 1, further comprising, in case that the item is selected:
receiving device information of the first user device from the first user device; and
broadcasting a second advertisement message for notifying of completion of an order service associated with the item selected based on the pointing location,
wherein the second advertisement message comprises the device information, type information indicating that a service supported through an advertisement message is an order notification service, and information for identifying the order service.

5. The method of claim 1,
wherein the first angle information indicates a first angle horizontal to a screen of the electronic device, and
wherein the second angle information indicates a second angle perpendicular to the screen of the electronic device.

6. A method of a user device performing UWB communication, the method comprising:
receiving a UWB advertisement message for angle of arrival (AoA) measurement;
acquiring first angle information, based on the UWB advertisement message being received, and second angle information, based on sensing information;
determining whether there is a user's intention to use a UWB-based service provided by an electronic device transmitting the UWB advertisement message, based on at least one of the first angle information and the second angle information; and
in case that there is the user's intention, transmitting the first angle information and the second angle information to the electronic device,
wherein the first angle information and the second angle information are used to identify a pointing location of the user device.

7. The method of claim 6, further comprising:
transferring device information of the user device to the electronic device.

8. The method of claim 7, further comprising:
receiving an advertisement message for notifying of completion of an order service associated with an item selected based on the pointing location,
wherein the advertisement message comprises the device information, type information indicating a type of a service supported through the advertisement message, and information for identifying the order service.

9. The method of claim 8, wherein the advertisement message is a BLE advertisement message or a UWB advertisement message.

10. An electronic device performing UWB communication, the electronic device comprising:
memory; and
a processor connected to the memory,
wherein the processor is configured to:
broadcast a UWB advertisement message for angle of arrival (AoA) measurement,
receive, from a first user device, first angle information acquired based on the UWB advertisement message being received, and second angle information acquired based on sensing information,
identify a pointing location, pointed by the first user device, by using the first angle information, the second angle information, and distance information acquired based on two-way ranging (TWR) with the first user device, and
determine whether an item associated with a UWB-based service provided by the electronic device is selected based on the pointing location.

11. The electronic device of claim 10,
wherein the processor is further configured to broadcast a first advertisement message for supporting an additional connection of a second user device, and
wherein the first advertisement message comprises information on the first user device and type information indicating that a service supported through an advertisement message is a group user service.

12. The electronic device of claim 11, wherein the first advertisement message is a BLE advertisement message or a UWB advertisement message.

13. The electronic device of claim 10,
wherein the processor is configured to, in case that the item is selected:
receive device information of the first user device from the first user device, and
broadcast a second advertisement message for notifying of completion of an order service associated with the item selected based on the pointing location, and
wherein the second advertisement message comprises the device information, type information indicating that a service supported through an advertisement message is an order notification service, and information for identifying the order service.

14. The electronic device of claim 10,
wherein the first angle information indicates a first angle horizontal to a screen of the electronic device, and
wherein the second angle information indicates a second angle perpendicular to the screen of the electronic device.

15. A user device performing UWB communication, the user device comprising:
memory; and
a processor connected to the memory,
wherein the processor is configured to:
receive a UWB advertisement message for angle of arrival (AoA) measurement,
acquire first angle information, based on the UWB advertisement message being received, and second angle information, based on sensing information,
determine whether there is a user's intention to use a UWB-based service provided by an electronic device transmitting the UWB advertisement message, based on at least one of the first angle information and the second angle information, and
in case that there is the user's intention, transmit the first angle information and the second angle information to the electronic device, and
wherein the first angle information and the second angle information are used to identify a pointing location of the user device.
